(19) United States
(12) Patent Application Publication
(10) Pub. No.: US 2021/0370864 A1
(43) Pub. Date: Dec. 2, 2021

(54) ACTIVE PEDESTRIAN PROTECTION SYSTEM USING NON-CONTACT FORWARD SENSING AND HOOD LATCH ASSEMBLY WITH SPRING LOADED ACTUATOR

(71) Applicant: MAGNA CLOSURES INC., Newmarket (CA)

(72) Inventor: John Distefano, Richmond Hill (CA)

(21) Appl. No.: 17/233,277

(22) Filed: Apr. 16, 2021

Related U.S. Application Data
(60) Provisional application No. 63/030,842, filed on May 27, 2020.

(51) Int. Cl. B60R 21/38; B60R 21/0136; E05B 83/24; B60R 21/0134; E05B 85/04; B60R 21/01

(52) U.S. Cl. CPC B60R 21/38; B60R 21/0136; E05B 83/243; B60R 2021/01013; E05B 85/04; E05Y 2900/536; B60R 21/0134

(57) ABSTRACT

A closure latch system and method for capturing, releasing, and recapturing a striker of a hood of a motor vehicle are provided. The closure latch system includes at least one power actuator configured for communication with at least one sensor. The at least one power actuator is actuatable in response to a signal from the at least one sensor indicating an imminent impact with a pedestrian to pivot the hood to a partially open position, and thereafter, to pivot the hood to a closed position in response to an indication of there being no impact from the at least one sensor.

### CROSS-REFERENCE TO RELATED APPLICATION

This application claims the benefit of U.S. Provisional Application Ser. No. 63/030,842, filed May 27, 2020, which is incorporated herein by reference in its entirety.

### FIELD

The present disclosure relates generally to a power-operated closure latch assembly for a motor vehicle closure system. More specifically, the present disclosure is directed to a closure latch assembly providing power release and power cinch functionality and which is well-suited for use with a front hood latching system in a motor vehicle.

### BACKGROUND

It is desired to best protect pedestrians against injury resulting from head on collisions with vehicles. When a car hits a pedestrian in a front end collision, the pedestrian can be thrown up and land on the front hood of the vehicle. In an effort to lessen the harshness of the impact of the pedestrian against the vehicle, and in particular to prevent the person's head from impacting the engine block or other hard object located directly beneath the front hood, it would be desirable to actively space the front hood from the engine block prior to the pedestrian impacting the front hood. In particular, when a front end collision is imminent, it would be desirable to move the front hood in a very short period of time (e.g., in milliseconds) from a fully closed first position, where the front hood is normally located immediately adjacent the engine block, to a second position where the front hood is actively and controllably moved further away from the engine block. The movement of the hood to the second position could provide the pedestrian's head and/or body with sufficient time and/or cushion space to more gradually decelerate as the pedestrian impacts the front hood, thereby potentially lessening the risk of severe injury to the pedestrian.

It is further desired to minimize the cost and complexity of motor vehicle safety systems and components thereof. Further yet, it is desired to be able to provide an ability to drive a vehicle away from an accident site without reasonable concern of the damaged hood opening while driving or otherwise transporting the vehicle. Additionally, it is desired to be able to minimize the number of components needed to be replaced upon actuation of the vehicle safety system. It is further desired to ensure sufficient and ample time exists to fully deploy the motor vehicle safety system prior to a person impacting the front hood of the vehicle, thereby minimizing the potential seriousness of injury the person. These desires, problems and others associated with accidents causing damage to a front hood and potential harm to a pedestrian impacting the front hood are recognized, as would be readily understood by those skilled in the art of vehicle closure panels.

While current closure latch assemblies with power release functionality are well suited to meet regulatory requirements and provide enhanced operational convenience, desired is a hood latch and system therewith which provides solutions to these issues, as well as other issues understood by a person skilled in the art of vehicle hood panels.

### SUMMARY

This section provides a general summary of the inventive solutions associated with the present disclosure. Accordingly, this section is not intended to be interpreted as a comprehensive and exhaustive listing of all features, aspects, objectives and/or advantages associated with the inventive solutions which are further described and illustrated in the following detailed description and the appended drawings.

It is an objective of the present disclosure to provide a motor vehicle hood latch and closure system therewith which addresses at least those issues discussed above.

It is a related objective of the present disclosure to further provide a motor vehicle hood latch and closure system therewith for use with any model of motor vehicle.

It is a further objective of the present disclosure to provide a motor vehicle hood latch and closure system therewith with an actuation system and release actuator having an ability to automatically sense an imminent front end impact and release a vehicle hood from a fully closed position to a partially open position without need of action from a driver of the vehicle and prior to a pedestrian impacting the vehicle hood.

It is a further objective of the present disclosure to provide a motor vehicle hood latch and closure system therewith with an ability to prevent the vehicle hood from inadvertently moving to a fully open position while transporting the vehicle after an accident.

It is a further objective of the present disclosure to provide a motor vehicle hood latch and closure system therewith that can be automatically deployed via detection of an imminent pedestrian impact, and reset, either automatically or manually, upon being deployed without need of service of the motor vehicle hood latch and closure system.

It is a further objective of the present disclosure to provide a hood latch system and method for capturing, releasing, and recapturing a striker of a hood of a motor vehicle. The hood latch system includes at least one electromechanical actuator configured for communication with at least one sensor. The electromechanical actuator is actuatable in response to a signal from the at least one sensor, indicating an imminent impact with a pedestrian, to pivot the hood to a partially open position, and thereafter, to pivot the hood to a closed position in response to an indication of there being no impact from the at least one sensor.

It is a further objective of the present disclosure to provide a hood latch system and method for capturing, automatically releasing, and automatically recapturing a striker of a hood of a motor vehicle. The hood latch system includes at least one power actuator configured for communication with a plurality of sensors. The power actuator is actuatable in response to a signal from one of the plurality of sensors, indicating an imminent impact with a pedestrian, to pivot the hood to a partially open position, and thereafter, to pivot the hood to a closed position in response to an indication of there being no impact from another of the plurality of sensors.

In accordance with these and other objectives, an active pedestrian protection system for moving a closure panel of a motor vehicle between a fully closed position and a partially open position is provided. The active pedestrian protection system includes a latch mechanism configured for retaining a striker coupled to the closure panel in a fully captured position, whereat the closure panel is in the fully closed position, a striker partial release position, whereat the closure panel is in the partially open position, and a striker release position, whereat the closure panel is permitted to move to a fully open position. The active pedestrian protection system includes actuation system comprising an actuation device having a first state and a second state, wherein transition of the actuation device from the first state to the second state causes movement of the closure panel from the fully closed position to the partially open position. At least one power actuator is operable to promote a transition of the actuation device from the first state to the second state. Further, at least one sensor is configured for sensing an object within a predetermined distance from the motor vehicle, and at least one controller is configured in communication with the at least one power actuator and with the at least one sensor. The at least one controller is configured to control the at least one power actuator in response to receiving a signal from the at least one sensor to cause the actuation device to transition from the first state to the second state, whereat the striker moves from the fully captured position to the striker partial release position and the closure panel correspondingly moves from the fully closed position to the partially open position.

In accordance with another aspect, the at least one sensor can include an impact detection sensor configured in communication with the at least one controller. The impact detection sensor is configured to detect an object impacting the motor vehicle, particularly the hood, wherein the at least one controller is configured to signal the at least one power actuator, and wherein absent receipt of a signal by the impact detection sensor indicating an object impacting the hood, the impact detection sensor signals the at least one controller to actuate the at least one power actuator to return the hood to the fully closed position. Accordingly, the vehicle is able to be driven in normal fashion upon the hood being moved from the partially open position back to the fully closed position.

In accordance with another aspect, the impact detection sensor automatically signals the at least one controller to actuate the at least one power actuator to return the hood to the fully closed state within a preset timeframe without input from a user.

In accordance with another aspect, the actuation device is a spring, wherein the first state corresponds to a loaded state of the spring and the second state corresponds to a released state of the spring.

In accordance with another aspect, the actuation device is not a pyrotechnic device.

In accordance with another aspect, the latch mechanism includes a ratchet and at least one pawl. The ratchet is moveable between a primary striker capture position, whereat the ratchet retains the striker in the fully captured position and whereat the hood is in the fully closed position, a striker partial release position, whereat the ratchet retains the striker in the partially released position and whereat the hood is in the partially open position, and a striker release position, whereat the ratchet releases the striker and whereat the hood can be moved to a fully open position. The at least one pawl is moveable between a lock position, whereat the at least one pawl holds the ratchet in one of the primary striker capture position or the striker partial release position, and a ratchet releasing position, whereat the at least one pawl releases the ratchet for movement from one of the primary striker capture position or the striker partial release position.

In accordance with another aspect, a lift lever is configured to move from a home position to a deployed position, wherein the at least one power actuator is configured for communication with the at least one sensor. The at least one power actuator is in operable communication with the lift lever and the at least one pawl. The at least one power actuator is actuatable in response to a signal from the at least one sensor to move the at least one pawl from the lock position to the ratchet releasing position and to move the lift lever from the home position to the deployed position to move the striker from the fully captured position to the partially released position and the hood from the fully closed position to the partially open position. The at least one power actuator is actuatable to return the striker from the partially released position to the fully captured position and the hood from the partially open position to the fully closed position.

In accordance with another aspect, the at least one power actuator includes a power release motor and a power cinch motor. The power release motor is configured to move the at least one pawl from the lock position to the ratchet releasing position and the power cinch motor is configured to return the striker from the partially released position to the fully captured position, whereupon the hood is moved from the partially open position to the fully closed position.

In accordance with another aspect, the at least one sensor includes a non-contact sensor configured to detect an object in a first zone, whereat the at least one power actuator is not actuated, and to detect a pedestrian in a second zone, whereat the at least one power actuator is actuated. The second zone extends from a front end of the motor vehicle to the first zone, and thus, the second zone is between the motor vehicle front end and the first zone.

In accordance with another aspect, the at least one sensor can be provided as part of an advanced driver assistance system, wherein the advanced driver assistance system can be configured to automatically steer and/or brake the motor vehicle in response to detection of an object in the first zone.

In accordance with a further aspect, a closure latch system for capturing, partially releasing and recapturing a striker of a hood of a motor vehicle is provided. The closure latch system includes a ratchet and at least one pawl. The ratchet is moveable between a primary striker capture position, whereat the ratchet retains the striker in a fully captured position and whereat the hood is in a fully closed position, a striker partial release position, whereat the ratchet retains the striker in a partially released position and whereat the hood is retained in a partially open position, and a striker release position, whereat the ratchet releases the striker and whereat the hood can be moved to a fully open position. The at least one pawl is moveable between a primary lock position, whereat the at least one pawl holds the ratchet in the primary striker capture position, a ratchet releasing position whereat the at least one pawl releases the ratchet to the striker partial release position. A lift lever is configured to pivot from a home position to a deployed position into forcible engagement with the striker. At least one power actuator is configured for communication with at least one sensor, with the at least one power actuator being in operable communication with the lift lever and the at least one pawl. The at least one power actuator is actuatable in response to a signal from the at least one sensor to pivot the at least one pawl out of locked engagement with the ratchet and to pivot the lift lever from its home position to its deployed position into forcible engagement with the striker to move the striker to the partially released position and the hood to the partially open position. The at least one power actuator is further actuatable in response to a signal from the at least one sensor to return the striker to the fully captured position and the hood to the fully closed position.

In accordance with another aspect of the disclosure, the hood latch can further include at least one controller configured in communication with the at least one sensor. The at least one controller is configured to signal the at least one power actuator, upon receipt of a signal from the at least one sensor, to pivot the at least one pawl out of locked engagement with the ratchet and to pivot the lift lever from its home position to its deployed position into forcible engagement with the striker to move and support the hood in the partially open position, and thereafter to signal the at least one power actuator to pivot the lift lever from its deployed position to its home position out of forcible engagement with the striker and to cause the ratchet to return to the primary striker capture position and return the hood to the fully closed state.

In accordance with another aspect of the disclosure, the at least one sensor includes an impact detection sensor configured in communication with the at least one controller. The impact detection sensor is configured to detect an object impacting the motor vehicle, wherein upon lack of receipt of a signal from the impact detection sensor indicating an object impact, the at least one controller is signaled to actuate the at least one power actuator to return the hood to the fully closed state.

In accordance with another aspect of the disclosure, the at least one power actuator can include a power release motor and a separate power cinch motor. The power release motor is configured to pivot the at least one pawl out of locked engagement with the ratchet and the power cinch motor is configured to return the striker from the partially released position to the fully captured position, thereby returning the hood from the partially open position to the fully closed position.

In accordance with another aspect of the disclosure, the at least one sensor can be configured to detect an object in a first zone associated with an advanced driver assistance system, whereat the at least one power actuator is not actuated, and to detect a pedestrian in a second zone, whereat the at least one power actuator is actuated, wherein the second zone extends from a front end of the motor vehicle to the first zone such that the second zone is between the first zone and the motor vehicle.

In accordance with another aspect of the disclosure, an active pedestrian protection system if provided for driving a closure panel of a motor vehicle from a closed position to a deployed position to dampen the impact of a pedestrian against the closure panel. The active pedestrian protection system includes a latch mechanism configured for retaining a striker coupled to the closure panel in at least one striker capture position whereat the closure panel is prevented from moving to a fully open position, and for releasing the striker whereat the closure panel is permitted to move to a fully open position. The active pedestrian protection system further includes an actuation system including an energy storage device having a loaded state and a released state wherein a transition of the energy stored device from the loaded state to the released state causes movement of the closure panel from the closed position to the deployed position, and a power actuator being operable to allow the transition of the energy stored device from the loaded state to the released state. At least one non-contact sensor is configured for sensing an object within a predetermined distance from the motor vehicle, and a controller is configured in communication with the power actuator and with the at least one non-contact sensor. The controller is configured to detect the object within the predetermined distance using the at least one non-contact sensor, and in response, control the power actuator to cause the energy storage device to transition to the release state to move the closure panel to the deployed position.

In accordance with another aspect of the disclosure, the energy storage device is a mechanical device.

In accordance with another aspect of the disclosure, the energy storage device is a spring.

In accordance with another aspect of the disclosure, the energy storage device is not a chemical device or a pyrotechnic device.

In accordance with another aspect of the disclosure, a cinching system is configured to move the closure panel from the deployed position to the closed position, wherein the cinch system comprising a powered actuator in communication with the controller.

In accordance with another aspect of the disclosure, the cinching system is part of the latch mechanism.

In accordance with another aspect of the disclosure, the controller is configured to control the powered actuator of the cinching system to move the closure panel from the deployed position to the closed position after controlling the power actuator of the actuation system.

In accordance with another aspect of the disclosure, the controller is configured to determine if a pedestrian impact with the motor vehicle has not been detected, and in response to not detecting a pedestrian impact, control the powered actuator of the cinching system to move the closure panel from the deployed position to the closed position.

In accordance with another aspect of the disclosure, the controller determines if a pedestrian impact with the motor vehicle has not been detected based on at least one of: receiving a signal input from a driver controlled switch; receiving a signal input from a vehicle system indicative of a normal driving state of the motor vehicle; and receiving a signal input from a vehicle accident detection system.

In accordance with another aspect of the disclosure, a method of automatically moving a hood of a motor vehicle from a fully closed position to a partially open position in advance of impacting a pedestrian to minimize the potential for injury to the pedestrian upon the pedestrian impacting the hood and for returning the hood from the partially open position to the fully closed position is provided. The method includes, sensing a pedestrian in front of the motor vehicle with a sensor and sending a signal from the sensor to a controller. Then, sending a signal from the controller to at least one power actuator of a latch assembly in response to the signal sent from the sensor to the controller, whereupon the at least one power actuator moves at least one pawl from a primary lock position, whereat the at least one pawl holds a ratchet in a primary striker capture position to maintain the hood in the fully closed position, to a ratchet releasing position whereat the at least one pawl allows the ratchet to move to a striker partial release position and a lift lever to pivot from a home position to a deployed position in forcible engagement with a striker to move the hood to the partially open position, whereat the ratchet maintains the hood in the partially open position. Then, sending a signal from the controller to the at least one power actuator to cinch the striker to a fully captured position and return the hood to the fully closed position whereat the ratchet retains the striker in the fully captured position.

In accordance with another aspect of the disclosure, the method can further include sending the signal from the controller to the at least one power actuator to return the ratchet from the striker partial release position to the primary striker capture position whereat the ratchet retains the striker in the fully captured position and the hood in the fully closed position in response to an impact detection sensor, configured in electrical communication with the controller, not detecting an impact against the motor vehicle.

In accordance with another aspect of the disclosure, the method can further include configuring the sensor to detect an object in a first zone associated with an advanced driver assistance system, whereat the at least one power actuator is not actuated, and to detect a pedestrian in a second zone, whereat the at least one power actuator is actuated, the second zone extending from a front end of the motor vehicle to the first zone such that the second zone is between the first zone and the motor vehicle.

In accordance with another aspect of the disclosure, the method can further include sending the signal from the controller to the at least one power actuator to cinch the striker to the fully captured position whereat the ratchet retains the striker in the fully captured position and the hood in the fully closed position in response to an operator actuating a cinch mechanism, configured in electrical communication with the controller.

In accordance with another aspect of the disclosure, the method can further include providing the at least one power actuator including a power release motor and a separate power cinch motor and configuring the power release motor to pivot the at least one pawl out of locked engagement with the ratchet and configuring the power cinch motor to cinch the striker from a partial release position to fully captured position whereat the ratchet retains the striker in the fully captured position and the hood in the fully closed position.

In accordance with another aspect of the disclosure, a method of automatically moving a hood of a motor vehicle from a closed position to an active pedestrian deployed position in advance of impacting a pedestrian to minimize the potential for injury to the pedestrian upon the pedestrian impacting the hood and returning the hood from the active pedestrian deployed position to the closed position, includes: sensing a pedestrian in front of the motor vehicle with a sensor; moving the closure panel from the closed position to the deployed position using an actuation system comprising a mechanical energy storage device controlled to release stored mechanical energy in response to sensing the pedestrian; moving the closure panel from the deployed position to the closed position using an cinching system; and storing mechanical energy in the mechanical energy storage device during the moving the closure panel from the deployed position to the closed position using the cinching system.

An active pedestrian protection system for moving a closure panel of a motor vehicle between a fully closed position and a partially open position, is described having a latch mechanism configured for retaining a striker coupled to the closure panel in a fully captured position, whereat the closure panel is in the fully closed position, a striker partial release position, whereat the closure panel is in the partially open position, and a striker release position, whereat the closure panel is permitted to move to a fully open position; and an actuation system comprising an actuation device having a first state and a second state wherein transition of the actuation device from the first state to the second state causes movement of the closure panel from the fully closed position to the partially open position during an active pedestrian protection mode, and at least one power actuator operable to promote a transition of the actuation device from the first state to the second state in a resetting mode. The actuation system may be in communication with a sensor system for detecting a pedestrian at a distance from the vehicle, the actuation system configured to transition from the first state to the second state in response to receiving a signal from the sensor system. The actuation system may be configured to control the latch mechanism to release the striker from the fully captured position to the striker partial release position in the active pedestrian protection mode and is further configured to control the latch mechanism move the striker from the striker partial release position to the fully captured position in the resetting mode. The actuation system may be configured to operate in the active pedestrian protection mode based on the state of the vehicle and the distance of the pedestrian detected from the vehicle. The state of the vehicle may be the speed of the vehicle. The latch may be configured having a power release function and a cinching function, and the actuation system is configured to control the power release function and the cinching function. The actuation system may be supported by a frame plate connected to the body of the vehicle, where the frame plate also supports the latch mechanism.

Further areas of applicability will become apparent from the description provided herein. The description and specific examples in this summary are only intended to illustrate certain non-limiting objects, aspects, and embodiments which are not intended to limit the scope of the present disclosure.

### BRIEF DESCRIPTION OF THE DRAWINGS

The drawings described herein are only intended to illustrate non-limiting embodiments of a power-operated closure latch assembly and its related structural configuration and functional operation in association with the teachings of the present disclosure. In the drawings:

FIG. 1 illustrates a motor vehicle equipped with a closure latch system including a power-operated closure latch assembly operable for releasably latching a closure panel, such as a hood, relative to a structural body portion of the motor vehicle;

FIGS. 2A and 2B are front and rear plan views of a closure latch assembly constructed according to a non-limiting embodiment of the present disclosure and configured to include a latch mechanism, a latch release mechanism, a spring-loaded lift mechanism, a safety latch mechanism, a latch cinch mechanism, and a power actuator;

FIGS. 3A and 3B are generally similar to FIGS. 2A and 2B, respectively, and illustrate the closure latch assembly with the latch mechanism in a latched state for holding the hood in a fully-closed position relative to the structural body portion of the motor vehicle;

FIGS. 4A and 4B are generally similar to FIGS. 3A and 3B, respectively, but illustrate initial actuation of the latch release mechanism via the power actuator for initiating a power release function;

FIGS. 5A and 5B are generally similar to FIGS. 4A and 4B, respectively, but illustrate continued actuation of the latch release mechanism via the power actuator;

FIGS. 6A and 6B are generally similar to FIGS. 5A and 5B, respectively, but illustrate the latch mechanism being shifted from its latched state into an unlatched state in response to continued actuation of the latch release mechanism;

FIGS. 7A and 7B are generally similar to FIGS. 6A and 6B, respectively, but illustrate continued actuation of the latch release mechanism results in the spring-loaded lift mechanism being shifted from a spring-loaded state into a spring-released state for causing the hood to move from its fully-closed position into a partially-opened or “pop-up” position relative to the structural body portion of the vehicle;

FIGS. 8A and 8B are generally similar to FIGS. 7A and 7B, respectively, but illustrate continued actuation of the latch release mechanism causing release of the safety latch mechanism to subsequently permit manual movement of the hood from its pop-up position into a fully-opened position relative to the structural body portion of the vehicle, and FIG. 8C illustrates the components of the safety latch mechanism interacting with the latch mechanism;

FIGS. 9A and 9B are front and rear plan views of the closure latch assembly showing initiation of a first (i.e. “non-driven”) cinching stage of a dual-stage hood cinch operation following manual movement of the hood from its fully-open position to its pop-up position;

FIGS. 10A and 10B are generally similar to FIGS. 9A and 9B, respectively, but illustrate movement of the various components of the closure latch assembly caused by movement of the hood under its own weight from its pop-up position toward a cinched position during continuation of the first cinching stage;

FIGS. 11A and 11B are generally similar to FIGS. 10A and 10B, respectively, but illustrate the components of the closure latch assembly upon the hood moving into its cinched position at the end of the first cinching stage;

FIGS. 12A and 12B are generally similar to FIGS. 11A and 11B, respectively, but illustrate initiation of a second (i.e. “driven”) cinching stage of the dual-stage hood cinch operation once the hood is located in its cinched position;

FIGS. 13A and 13B are generally similar to FIGS. 12A and 12B, respectively, but illustrate continuation of the second cinching stage of the dual-stage hood cinch operation for moving the hood from its cinched position toward its fully-closed position;

FIGS. 14A and 14B are generally similar to FIGS. 13A and 13B, respectively, but illustrate the components of the closure latch assembly upon movement of the hood into its fully-closed position as part of the second cinching stage;

FIGS. 15A and 15B are generally similar to FIGS. 14A and 14B, respectively, but illustrate the hood moved slightly past its fully-closed position into an overtravel position as part of the second cinching stage of the dual-stage hood cinch operation;

FIGS. 16A and 16B are generally similar to FIGS. 15A and 15B, respectively, but illustrate movement of the components of the closure latch assembly as the hood moves back from its overtravel position toward its fully-closed position;

FIGS. 17A and 17B are generally similar to FIGS. 16A and 16B, respectively, but illustrate the closure latch assembly upon completion of the second cinching stage of the dual-stage hood cinch operation with the hood latched in its fully-closed position;

FIGS. 18A and 18B are generally similar to FIGS. 17A and 17B, respectively, but illustrate the closure latch assembly being reset following completion of the dual-stage hood cinch operation;

FIGS. 19A and 19B are front and rear plan views of a closure latch assembly of a closure latch system constructed according to an alternative non-limiting embodiment of the present disclosure and which is configured to include a latch mechanism, a latch release mechanism, a power release actuator, and a lift and cinch mechanism actuated by an external power cinch actuator, the closure latch assembly shown in a primary latched mode with the latch mechanism operating in a latched state for holding the hood in its fully-closed position;

FIGS. 20A and 20B are generally similar to FIGS. 19A and 19B, respectively, but illustrate the latch mechanism operating in an unlatched state following completion of a power release operation to permit manual movement of the hood from its pop-up position toward its fully-open position;

FIGS. 21A and 21B are front and rear plan views of the closure latch assembly showing movement of the hood from its fully-open position toward its pop-up position in response to a manual closing operation;

FIGS. 22A and 22B are generally similar to FIGS. 21A and 21B, respectively, but illustrate initiation of a first cinching stage of a dual-stage hood cinch operation once the hood is located in its pop-up position via actuation of the power cinch actuator;

FIGS. 23A and 23B are generally similar to FIGS. 22A and 22B, respectively, but illustrate movement of various components associated with the latch mechanism and the lift and cinch mechanism as the hood moves under its own weight toward its cinched position;

FIGS. 24A and 24B are generally similar to FIGS. 23A and 23B, respectively, but illustrate the location of the various components of the latch mechanism and the lift and cinch mechanism upon the hood being located in its cinched position at the completion of the first cinching stage;

FIGS. 25A and 25B are generally similar to FIGS. 24A and 24B, respectively, but illustrate initiation of a second cinching stage of the dual-stage hood cinch operation once the hood is located in its cinched position in response to continued actuation of the power cinch actuator;

FIGS. 26A and 26B are generally similar to FIGS. 25A and 25B, respectively, but illustrate the lift and cinch mechanism causing the latch mechanism to move the hood from its cinched position into its fully-closed position;

FIGS. 27A and 27B illustrate the lift and cinch mechanism causing the latch mechanism to move the hood from its fully-closed position into its overtravel position during continuation of the second cinching stage;

FIGS. 28A and 28B are generally similar to FIGS. 27A and 27B, respectively, but illustrate the closure latch assembly upon completion of the second cinching stage with the hood held by the latch mechanism in its fully-closed position;

FIGS. 29 through 33 illustrate a sequence events of a closure latch system upon detection of a pedestrian entering a pedestrian protection zone to protect the pedestrian prior to the pedestrian impacting a hood of the motor vehicle;

FIGS. 34 through 36 illustrate a sequence of the power latch system events upon determining a false pedestrian detection has occurred;

FIGS. 37 and 37A illustrate system block diagrams in accordance with alternative embodiments;

FIG. 38 illustrates a method flow diagram of a power latch system for automatically moving a hood of a motor vehicle from a closed state to a partially open state in advance of impacting a pedestrian to minimize the potential for injury to the pedestrian and returning the hood, automatically via a sensor/controller communication, from the partially open state to the closed state upon determining a false pedestrian detection occurred;

FIG. 39 illustrates a method of automatically moving a hood of a motor vehicle from a closed position to an active pedestrian deployed position in advance of impacting a pedestrian to minimize the potential for injury to the pedestrian upon the pedestrian (P) impacting the hood (12) and returning the hood (12) from the active pedestrian deployed position to the closed position; and

FIGS. 40A to 40C illustrate a sequence of views illustrating automatically moving a hood of a motor vehicle from a closed position to an active pedestrian deployed position in advance of impacting a pedestrian using a latch assembly and cinching system in accordance with another illustrative embodiment.

### DETAILED DESCRIPTION OF EXAMPLE EMBODIMENTS

Example embodiments of an active pedestrian system for use in a closure latch system of a motor vehicle will now be described more fully with reference to the accompanying drawings. To this end, the example embodiments of the active pedestrian system, closure latch system therewith and closure latch assembly thereof are provided so that the disclosure will be thorough and will fully convey its intended scope to those who are skilled in the art. Accordingly, numerous specific details are set forth such as examples of specific components, devices, and methods, to provide a thorough understanding of particular embodiments of the present disclosure. However, it will be apparently to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

In the following detailed description, the expression “closure latch assembly” will be used to generally indicate any power-operated latch device adapted for use with a vehicle closure panel and which is configured to provide at least one of a power cinch feature and a power release feature. Additionally, the expression “closure panel” will be used to indicate any element mounted to a structural body portion of a motor vehicle and which is moveable between a fully-open position and a fully-closed position, respectively opening and closing an access to a passenger or storage compartment of the motor vehicle. Without limitations, closure panel herein is described in relation to front hoods of motor vehicles.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

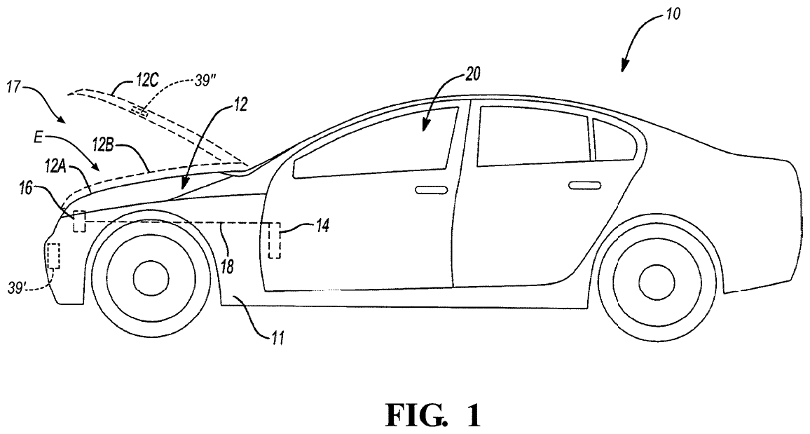

FIG. 1 illustrates a motor vehicle 10 having a body 11 defining a front compartment, which in some embodiments may be an engine compartment and in other embodiments may be a storage compartment. In this non-limiting example of motor vehicle 10, a closure panel, configured as a front hood, also referred to simply as hood 12, is mounted to body 11 for movement relative to the front compartment between a fully-closed position 12A, a partially-open or pop-up position 12B; and a fully-open position 12C. Illustratively, the closure panel is a hood provided at the front of the motor vehicle 10 for enclosing an engine bay or a frunk or stowage compartment. Hood 12 may be manually released via pulling a release handle 14 located within a passenger compartment 20 of vehicle 10 and which functions to actuate a latch release mechanism associated with a closure latch assembly 16 for releasing hood 12 and permitting subsequent pivotal movement of hood 12 to its pop-up position. A release cable 18 is shown to interconnect release handle 14 to the latch release mechanism associated with closure latch assembly 16. A safety latch mechanism also associated with closure latch assembly 16 can then be manually actuated to permit hood 12 to be moved from its pop-up position into its fully-open position. Release of the safety latch mechanism can be provided via a second pulling of release handle 14. Closure latch assembly 16 is, in this non-limiting embodiment, secured to a structural portion of vehicle body 11 adjacent to the front compartment and is configured to releasably engage a striker 22 mounted to an underside of hood 12. In addition to this otherwise conventional mechanical release of closure latch assembly 16, the present disclosure is directed to providing closure latch assembly 16 with a power release function (selectively actuatable by an operator and automatically actuatable via a sensor/controller, as discussed further below) and a power cinch function (selectively actuatable by an operator and automatically actuatable via a sensor/controller, as discussed further below).

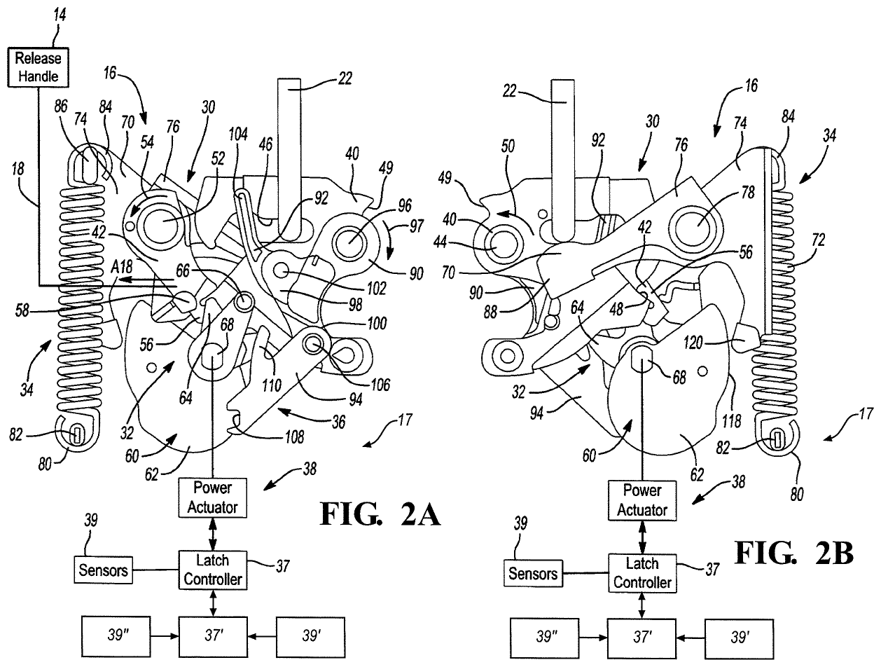

A detailed description of a non-limiting embodiment of a power-operated version of closure latch assembly 16 of a closure latch system 17 including an active pedestrian protection system (APPS), constructed in accordance with the teachings of the present disclosure, will now be provided with reference to FIGS. 2 through 18. In other possible configurations of the closure latch system 17, closure latch assembly 16 may be configured as a latch allowing movement of the hood 12 to a deployed position without the latch assembly 17 releasing the striker 22, for example as shown in commonly owned US Patent Application No. US20190152426A1, which is incorporated herein by way of reference in its entirety. Referring initially to FIGS. 2A and 2B, closure latch assembly 16 is generally shown to include a latch mechanism 30, a latch release mechanism 32, a spring-loaded lift mechanism 34, a latch cinch mechanism 36, and an electromechanical actuator, also referred to as power actuator 38. As will be detailed, power actuator 38 is operable to control actuation of latch release mechanism 32 to provide a power release function and to control actuation of latch cinch mechanism 36 to provide a power cinch function. A latch controller 37 is schematically shown in communication with power actuator 38 for controlling actuation thereof in response to sensor signals inputted to latch controller 37 from one or more latch sensors 39. The sensor signals can include, without limitation, a power release request (i.e. via key fob or push button) as well as positional signals indicative of the position of various components associated with one or more of the above-noted mechanism. While only shown schematically, power actuator 38 is intended to be configured to include, in this non-limiting example, at least one electric motor that is operable to actuate a drive mechanism operably associated with latch release mechanism 32 and latch cinch mechanism 36, as will be detailed. Closure latch assembly 16 also includes a frame plate and cover plate configured to define a latch housing (not shown) which supports each of the above-noted mechanisms and power actuator 38. The latch housing is fixedly secured to an edge portion of vehicle body 11 adjacent to the front compartment and defines an entry aperture through which striker 22 travels upon movement of hood 12 relative to vehicle body 11.

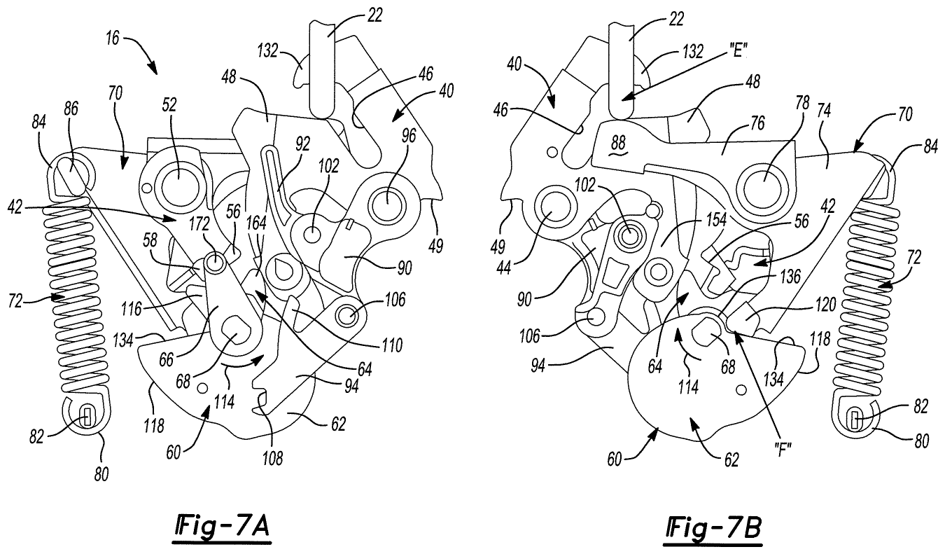

In addition to latch controller 37, a vehicle controller 37′ (e.g. vehicle computer, such as an electronic control unit or a Body Control Module (BCM), is provided and configured in electrical communication with at least one or a plurality of sensors 39′, 39″ of a sensor system located on the vehicle body 11 and/or on the hood 12 (e.g. at the front of the vehicle 10 such as in the vehicle front bumper and/or on hood 12) and with closure latch assembly 16. BCM 37′ may act as a vehicle accident detection system capable of discerning a crash condition of the vehicle using different sensors for example. Alternatively a distinct vehicle accident detection system or module may be in communication with the BCM 37′. In a possible configuration the sensor system is an Advanced Driver-Assistance Systems (ADAS) system. Upon sensor 39′ (non-contact sensor, e.g. radar sensor) detecting an imminent side or frontal crash/impact, sensor 39′ communicates with vehicle controller 37′ and/or directly with controller 37, whereupon vehicle controller 37′ operates in an active pedestrian protection mode and sends a trigger signal to actuate power actuator 38 of closure latch assembly 16 to automatically cause the closure latch assembly 16 to move closure latch assembly 16 to the partially opened (pop-up) position (FIGS. 7A and 7B), thereby causing the hood 12, fixed to striker 22, to be moved to the partially open position within milliseconds of the signal being received and sent by sensor 39′ to controllers 37, 37′, with it to be understood vehicle controller 37′ is configured in communication with controller 37, wherein the hood 12 is suddenly moved away from an underlying engine 26, thereby provided an increased space between the hood 12 and engine E. For example, the vehicle 10 moving at 35 kilometers per hour with the closure latch assembly 16 configured to move the hood 12 to the active pedestrian protection pop up position in approximately 200 milliseconds may require a detection of a pedestrian at 2 meters from the front of the vehicle 10 to allow time for the hood 12 to reach the pop up pedestrian protection position. It is recognized that the time period for the closure latch assembly 16 to move the hood 12 to the pop-up position may be more or less, and the closure latch 16 may be adapted to move the hood 12 in other time periods depending on the size and weight of the hood 12 and/or the spring constant, size and type, used in the closure assembly 16, as examples, as well as other vehicle dynamics such as use of active braking (e.g. the vehicle 10 will automatically brake without driver intervention when a pedestrian is detected). In a possible configuration, the controller 37 is configured to adapt the trigger distance, or in other words the distance from the vehicle 10 to a detected pedestrian or object at which the controller 27 will activate the closure latch assembly 16 configured to move the hood 12 to the active pedestrian protection pop up position, and for example the controller 37 is configured to adapt the trigger distance based on the speed of the vehicle 10. For example, at higher speeds, such as between 35 to 60 kilometers per hour, the controller 27 may be configured to activate the closure latch assembly 16 when an object is detected beyond 2 meters to allow sufficient time for the closure assembly 16 to deploy to the active pop-up position. Still as a further example, the controller 37 may also be configured to adapt to vehicle 10 speed such that above a cut-off or deactivation speed, such as a speed of 60 kilometers per hour, the controller 37 may not deploy the closure assembly 16. For example, at slower speeds, such as between 5 to 35 kilometers per hour, the controller 27 may be configured to activate the closure latch assembly 16 when an object is detected below 2 meters to the front of the vehicle 12 to avoid false detections and activations.

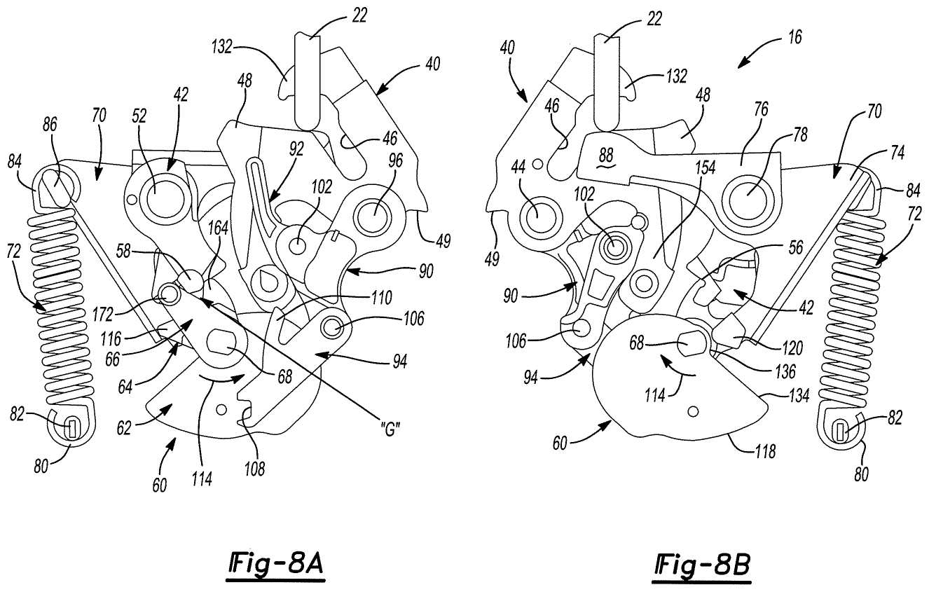

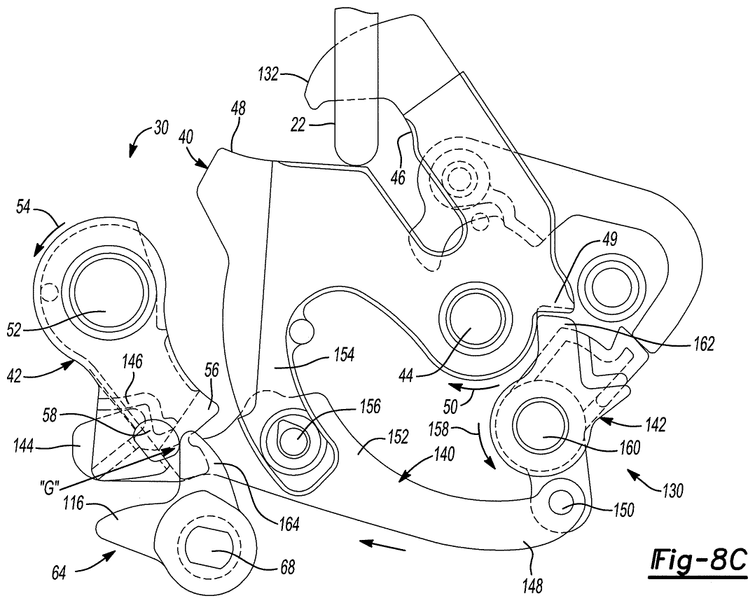

Accordingly, if a pedestrian subsequently impacts the hood 12 after actuation of closure latch assembly 16 and release mechanism 32 thereof, a cushioned effect of the slightly raised hood 12 is provided, which lessens the impact force to the pedestrian, and can ultimately reduce the potential of the pedestrian impacting the engine E, thereby reducing the potential for injury to the pedestrian. However, if sensor 39″ (e.g. an accelerometer configured to detect an actual impact force on vehicle, such as against front bumper and/or hood 12) does not detect an impact force within predetermined amount of time (timeframe) from the time of hood 12 moving to the partially open position, such as 0.5-5 seconds, by way of example and without limitation, sensor 39″ communicates with vehicle controller 37′ and/or directly with controller 37, whereupon vehicle controller 37′ and/or controller 37 operates in a resetting mode and sends a trigger signal to actuate a cinch actuator (power actuator 38) of closure latch assembly 16 to automatically cause the closure latch assembly 16 to move from the partially open position (FIGS. 8A and 8B) back to the closed position (FIGS. 2A and 2B), thereby causing the hood 12, fixed to striker 22, to be moved from the partially open position to the closed position, thereby allowing vehicle 11 to be driven in normal fashion with hood 12 fully closed without need of input from the driver.

Latch mechanism 30 is shown, in this non-limiting example, as a single ratchet and pawl arrangement including a ratchet 40 and a pawl 42. Pawl 42 may be operably connected to release handle 14 via release cable 18 to impart a pivoting of pawl 42, illustratively in a clockwise direction as viewed in FIG. 2A, in response to an activation of release handle 14. Ratchet 40 is supported in the latch housing via a ratchet pivot post 44 for rotational movement between several distinct positions including a striker release position, a secondary striker capture position, a cinched striker capture position, a primary striker capture position, and an overtravel striker capture position. Ratchet 40 is configured to include a primary latch shoulder 48 and a secondary latch shoulder 49. A ratchet biasing mechanism or member, schematically indicated by an arrow 50, is adapted to normally bias ratchet 40 to rotate about ratchet pivot post 44 in a first or “releasing” direction toward its striker release position.

Pawl 42 is supported in the latch housing by a pawl pivot post 52 for rotational movement between a ratchet holding position and a ratchet releasing position. A pawl biasing mechanism or member, schematically indicated by an arrow 54 (FIG. 8C), is adapted to normally bias pawl 42 toward its ratchet holding position. Pawl is 42 is configured to include a pawl latch lug 56 and a pawl release lug 58. FIGS. 2A and 2B illustrate ratchet 40 held in its primary striker capture position by pawl 42 when pawl 42 is located in its ratchet holding position due to pawl latch lug 56 engaging primary latch shoulder 48 on ratchet 40.

The drive mechanism, also referred to as actuator mechanism, is shown to include a drive cam 60 comprised of a drive cam lift lever 62, a drive cam pawl release lever 64, and a drive cam cinch lever 66, all of which are connected in a “stacked” arrangement for common rotation about a drive cam pivot post 68. While shown as distinct components, the above-noted levers of drive cam 60 can be formed together as a single drive cam member as an alternative to the multi-piece configuration shown. As will be detailed, drive cam 60 is only rotated in a single or “actuation” direction (i.e. counterclockwise in FIG. 2A and clockwise in FIG. 2B) via actuation of the electric motor associated with power actuator 38. As will be detailed, drive cam lift lever 62 is operably associated with lift mechanism 34, drive cam pawl release lever 64 is operably associated with latch release mechanism 32, and drive cam cinch lever 66 is operably associated with latch cinch mechanism 36.

Lift mechanism 34 is generally shown to include a lift lever 70 and an actuation device, shown, by way of example and without limitation as an energy storage device 72 having a loaded state and a released state wherein a transition of the energy stored device 72 from the loaded state to the released state causes movement of lift lever 70 and the closure panel 12 from the closed position to the deployed position. Energy storage device 70 can be provided as a spring member, and referred to hereafter as lift lever spring 72. Lift lever 70 includes a spring plate segment 74 and a striker plate segment 76, both of which are connected for common rotation about a lift lever pivot post 78. While not limited thereto, lift lever pivot post 78 and pawl pivot post 52 may be commonly aligned to define a common pivot axis. Lift lever spring 72 has a first spring end segment 80 coupled to a stationary lug 82 extending from the latch housing and a second spring end segment 84 coupled to a retention lug 86 extending from spring plate segment 74 of lift lever 70. Lift lever spring 72 is operable to transition from a first state corresponding to the loaded state to a second state corresponding to the released state to normally bias lift lever 70 respectively from a home position in a pop-up direction to a deployed position (i.e. counterclockwise in FIG. 2A and clockwise in FIG. 2B). Striker plate segment 76 of lift lever 70 has a striker lug 88 that is adapted to selectively engage striker 22.

Latch cinch mechanism 36 is shown, in this non-limiting embodiment, to generally include a cinch lever 90, a cinch pawl 92, and a transmission lever 94. Cinch lever 90 is pivotably mounted to the latch housing via a cinch lever pivot post 96. Cinch lever pivot post 96 may be commonly aligned with ratchet pivot post 44 to define a common pivot axis. A cinch lever biasing mechanism or member, schematically indicated by an arrow 97 (FIG. 2A), is adapted to normally bias cinch lever 90 toward a first or “home” position. Cinch lever 90 includes a first pivot lug segment 98 and a second pivot lug segment 100. Cinch pawl 92 is pivotably coupled to first pivot lug segment 98 on cinch lever 90 via a cinch pawl pivot post 102 and has a cinch pawl drive lug 104 configured to be selectively engageable with ratchet 40. Transmission lever 94 has a first end segment pivotably coupled to second pivot lug segment 100 on cinch lever 90 via a transmission lever pivot post 106, a second end segment defining a drive slot 108, and an intermediate segment defining a transmission drive lug 110.

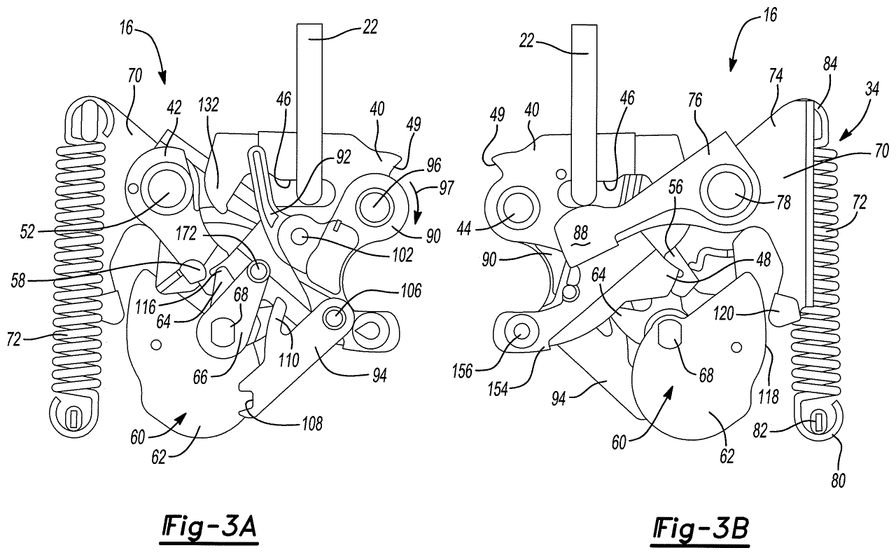

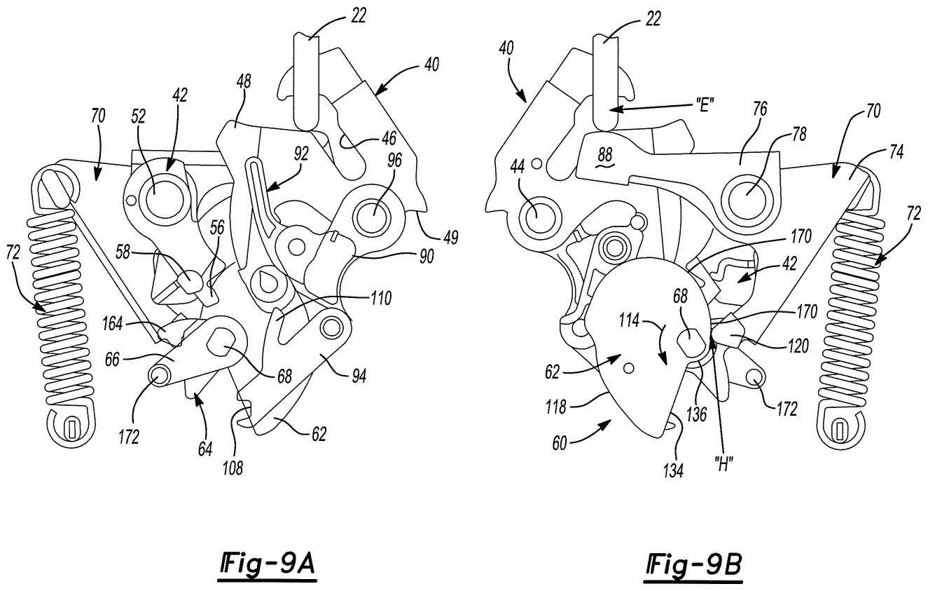

As will be hereinafter detailed, FIGS. 3 through 18 provide a series of sequential front and rear plan views of closure latch assembly 16 illustrating rotation of drive cam 60 via power actuator 38 to initiate and complete a power-operated primary latch release operation (FIGS. 3-7), to initiate and complete a power-operated safety latch release operation (FIGS. 8A-8C), and to initiate and complete a dual-stage hood cinch operation (FIGS. 9-18). Thus, closure latch assembly 16 is equipped with an “integrated” power-operated actuation arrangement having the single power actuator 38, by way of example and without limitation, located within the latch housing. The sequential views illustrate movement of the various components and mechanisms associated with closure latch assembly 16 to provide these distinct operations.

FIGS. 3A and 3B illustrate closure latch assembly 16 operating in a primary latched mode for holding hood 12 in its fully-closed position relative to body portion 11 of vehicle 10. With closure latch assembly 16 in its primary latched mode, latch mechanism 30 is operating in a primary latched state with ratchet 40 located in its primary striker capture position and pawl 42 located in its ratchet holding position. In addition, latch release mechanism 32 is shown operating in a non-actuated state with drive cam 60 located in a first or “home” position. Striker 22 is shown captured/retained within striker guide channel 46 of ratchet 40 such that striker 22 engages and acts on striker lug 88 of striker plate segment 76 so as to forcibly locate lift lever 70 in a first or “non-deployed” position, in opposition to the energy imparting bias of lift lever spring 72, thereby placing lift mechanism 34 in a spring-loaded state. Finally, latch cinch mechanism 36 is shown operating in an uncoupled state with cinch lever 90 located by cinch lever biasing member 97 in a first or “home” position. Note that location of cinch lever 90 in its home position also results in cinch pawl 92 and transmission lever 94 being located in their respective first or “home” positions.

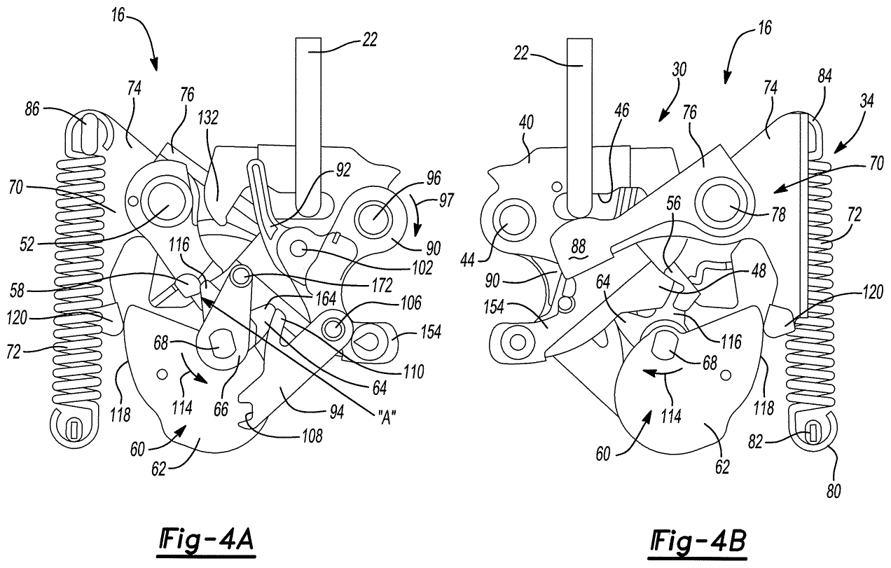

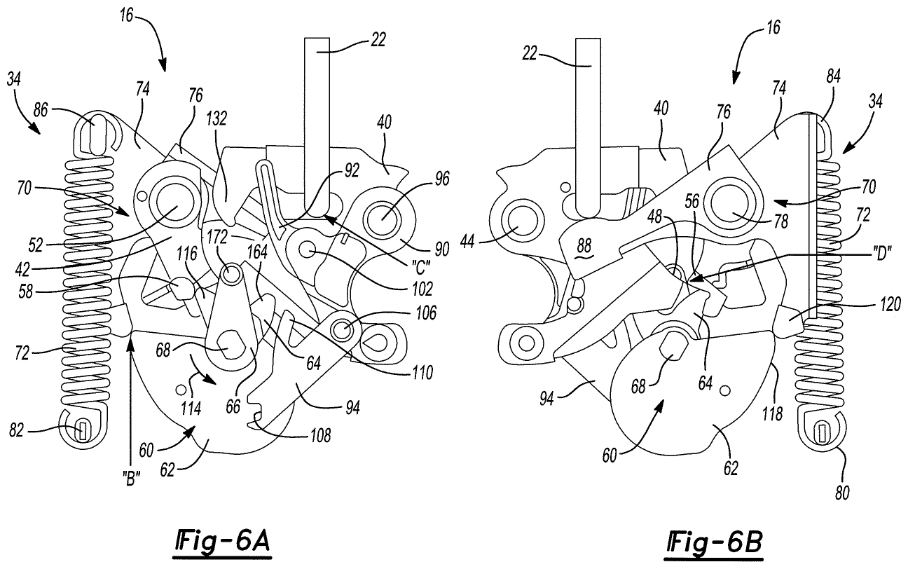

FIGS. 4A and 4B illustrate, in comparison to FIGS. 3A and 3B, respectively, initiation of the power release operation in response to latch controller 37 receiving a power release signal, such as from one of sensors 39, 39′. Specifically, an actuation system, including power actuator 38 and actuator member 72, wherein power actuator 38 has been actuated such that the electric motor causes drive cam 60 to begin rotating in the actuation direction (see arrow 114) from its home position toward a second or “pawl released” position (shown in FIGS. 6A, 6B). This initial driven rotation of drive cam 60 in the actuation direction causes a first pawl trigger lug 116 formed on drive cam pawl release lever 64 to engage pawl release lug 58 on pawl 42, as indicated by arrow “A” in FIG. 4A. This engagement causes pawl 42 to begin moving from its ratchet holding position toward its ratchet releasing position, in opposition to the biasing of pawl biasing member 54. In addition, a profiled cam edge surface 118 formed on drive cam lift lever 62 moves into engagement with a follower lug 120 formed on spring plate segment 74 of lift lever 70.

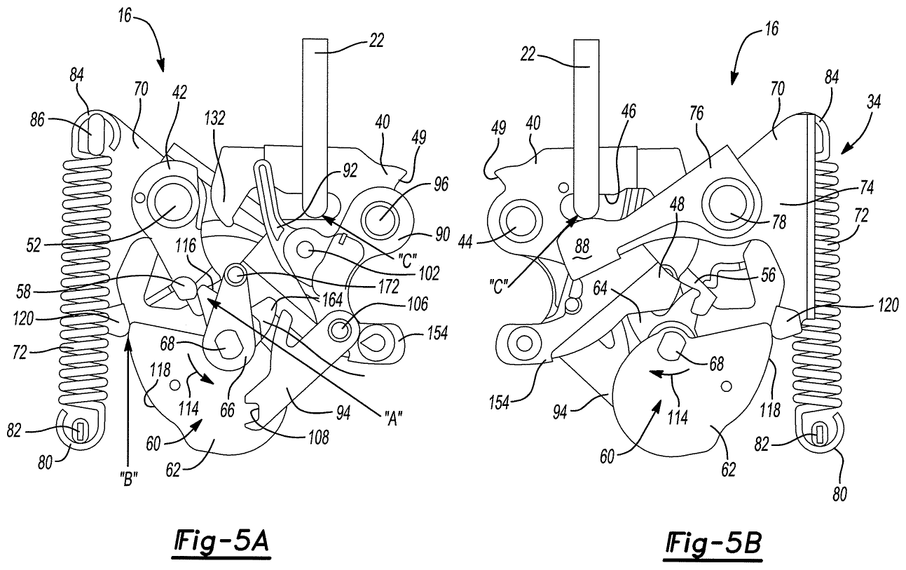

FIGS. 5A and 5B illustrate, in comparison to FIGS. 4A and 4B, respectively, continued driven rotation of drive cam 60 in the actuation direction by power actuator 38 causes continued movement of pawl 42 toward its ratchet releasing position due to first pawl trigger lug 116 on drive cam pawl release lever 64 continuing to forcibly act on pawl release lug 58 on pawl 42 (see arrow “A” of FIG. 5A). In addition, the profile of cam edge surface 118 on drive cam lift lever 62 is configured to forcibly act on follower lug 120 on spring plate segment 74, as indicated by arrow “B” of FIG. 5A, for causing lift lever 70 to rotate slightly in a downward (i.e. clockwise in FIG. 5A and counterclockwise in FIG. 5B) direction. This slight rotation of lift lever 70 causes striker 22 to disengage striker lug 88 on striker plate segment 26, as indicated by arrow “C”, thereby reducing the force exerted by lift lever spring 72 on striker 22. With striker lug 88 displaced from engagement with striker 22, the only forces acting on striker 22 in the releasing direction are the seal loads which may result in reduced ratchet/striker noise upon release of latch mechanism 30.

FIGS. 6A and 6B illustrate, in comparison to FIGS. 5A and 5B, respectively, that continued driven rotation of drive cam 60 in the actuation direction into its pawl released position functions to shift latch release mechanism 32 from its non-actuated state into an actuated state such that pawl 42 is now located in its ratchet releasing position. As such, pawl latch lug 56 on pawl 42 is disengaged from primary latch shoulder 48 on ratchet 40 (as indicated by arrow “D” in FIG. 6B) for defining a primary unlatched state for latch mechanism 30. Simultaneously, the profile of cam edge surface 118 on drive cam lift lever 62 is configured to now cause follower lug 120 (see arrow “B”) to rotate lift lever 70 slightly upwardly until striker lug 88 re-engages striker 22. At this point, lift mechanism 34 shifts from its spring-loaded state into a spring-released (i.e. “pop-up”) state and initiates a pop-up function.

FIGS. 7A and 7B illustrate, in comparison to FIGS. 6A and 6B, respectively, that shifting of latch mechanism 30 into its primary unlatched state permits ratchet biasing member 50 to forcibly drive ratchet 40 from its primary striker capture position into its secondary striker capture position. Concurrently, the shifting of lift mechanism 34 into its spring-released state causes lift lever spring 72 to forcibly drive lift lever 70 in the pop-up direction from its non-deployed position into a second or “deployed” position. As will be detailed, a safety latch mechanism 130 (FIG. 8C) is operable in a safety latched state to engage and hold ratchet 40 in its secondary striker capture position so as to define a secondary latched state for latch mechanism 30, wherein hood 12 is releasably maintained in its partially opened (pop-up) position. With ratchet 40 held in its secondary striker capture position by safety latch mechanism 130, striker 22 is prevented from exiting striker guide channel 46 via engagement with a hooked end segment (i.e. “safety hook”) 132 formed on ratchet 40. However, pivotal movement of lift lever 70 to its deployed position results in striker lug 88 on striker plate segment 76 engaging and forcibly driving striker 22 upwardly (see arrow “E”), thereby causing lift mechanism 34 to move hood 12 from its fully-closed position into its pop-up position. As such, closure latch assembly 16 has been shifted from its primary latched mode into a secondary latched mode. Note also that follower lug 120 has disengaged cam edge surface 118 and now slides along a follower edge surface 134 until it abuts a stop shoulder 136 formed on drive cam lift lever 62 (see arrow “F”). The interaction between follower lug 120 on spring plate segment 74 and stop shoulder 136 on drive cam lift lever 62 acts to positively locate lift lever 70 in its deployed position and complete the pop-up function. First pawl trigger lug 116 on drive cam pawl release lever 64 is also shown to have moved past and out of engagement with pawl release lug 58, thereby allowing pawl biasing member 54 to bias pawl 42 to move toward its ratchet holding position. The pop-up position of hood 12 is selected to be raised a predetermined amount with respect to its fully-closed position. The predetermined amount of hood travel is, in this non-limiting embodiment, selected for the pop-up position of hood 12 to be about 25 mm.

FIGS. 8A and 8B illustrate latch mechanism 30 operating in its secondary latched state and spring-loaded lift mechanism 34 operating it its spring-released state while FIG. 8C illustrates safety latch mechanism 130 operating in its safety latched state for holding ratchet 40 in its secondary striker capture position. Safety latch mechanism 130 is best shown in FIG. 8C to generally include a coupling link 140 and a safety pawl 142. Coupling link 140 has a first end segment 144 engaged with a drive lug 146 formed on pawl 42, a second end segment 148 pivotally connected to safety pawl 142 via a first coupling link pivot post 150, and an intermediate segment 152 pivotally connected to a leg extension segment 154 of ratchet 40 via a second coupling link pivot post 156. Safety pawl 142 is mounted to the latch housing by a safety pawl pivot post 160 for movement between a first or “ratchet blocked” position (shown) and a second or “ratchet unblocked” position. A safety pawl biasing mechanism or member, schematically indicated by an arrow 158, is arranged to normally bias safety pawl 142 toward its ratchet blocked position. In its ratchet blocked position, a blocker lug 162 on safety pawl 142 engages secondary latch shoulder 49 on ratchet 40, thereby mechanically holding ratchet 40 in its secondary striker capture position. Thus, FIG. 8C illustrates safety latch mechanism 130 operating in its safety latched state and latch mechanism 30 operating in its secondary latched state.

Continued driven rotation of drive cam 60 in its actuation direction from its pawl released position toward a third or “safety pawl released” position causes a second pawl trigger lug 164 on drive cam pawl release lever 64 to engage pawl release lug 58 on pawl 42, as indicated by arrow “G”. As such, pawl 42 is again rotated about pawl pivot 52, in opposition to the biasing of pawl biasing member 54, toward its ratchet releasing position which, in turn, causes corresponding movement of coupling link 140 due to engagement of pawl drive lug 146 with first end segment 144 of coupling link 140. Such movement of coupling link 140 results in movement of safety pawl 142 from its ratchet blocked position into its ratchet unblocked position, whereby blocker lug 162 is released from engagement with secondary latch shoulder 49 on ratchet 40, thereby establishing a safety unlatched state for safety latch mechanism 130 and an unlatched state for latch mechanism 30. Specifically, with safety pawl 142 located in its ratchet unblocked position, ratchet biasing member 50 is permitted to drive ratchet 40 from its secondary striker capture position into its striker release position, thereby releasing striker 22 from ratchet 40 so as to permit subsequent manual movement of hood 12 from its pop-up position to its fully-open position since striker 22 is no longer retained within guide channel 46 nor movement limited by safety hook segment 132. In this arrangement, closure latch assembly 16 is, due to shifting of safety latch mechanism 130 into its safety unlatched state, shifted from its secondary latched mode into its released mode. Once ratchet 40 is located in its striker release position, power actuator 38 is placed in a power-off state so as to stop further rotation of drive cam 60.

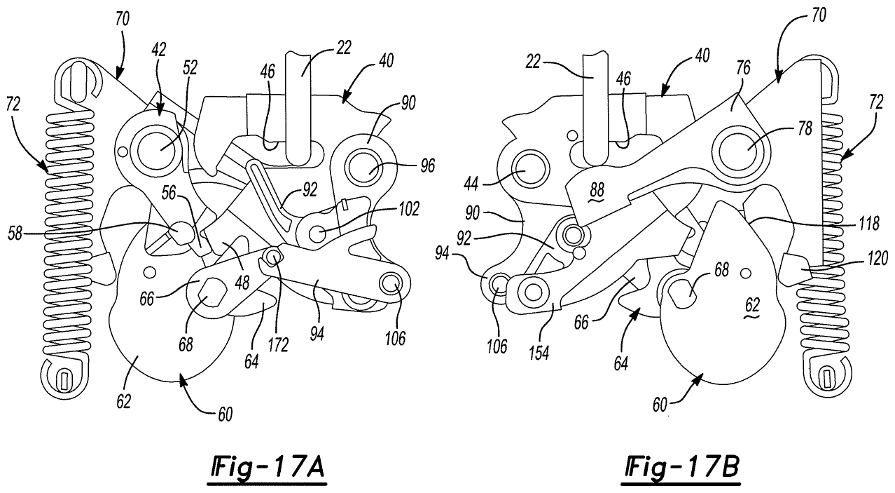

FIGS. 3 through 8 have clearly illustrated initiation and completion of the power release function via driven rotation of drive cam 60 in the actuation direction from its home position (FIGS. 3A, 3B) into its pawl released position (FIGS. 6A, 6B) and further into its safety pawl released position (FIGS. 8A-8C) due to actuation of power actuator 38. Now, FIGS. 9 through 17 will be described with similar detail to clearly illustrate initiation and completion of a dual-stage cinch function operable for moving hood 12 from its pop-up position (FIGS. 9A, 9B) to its fully-closed position (FIGS. 17A, 17B) in response to selective actuation of power actuator 38 and driven rotation of drive cam 60 in the actuation direction from its safety pawl released position back to its home position.

In accordance with the present disclosure, the dual-stage cinch function associated with closure latch assembly 16 can include a first or “non-driven” cinching stage and a second or “driven” cinching stage. The first cinching stage of the cinch operation functions to move hood 12 from a first stage start position to a first stage end position can use only the weight of the hood 12. Preferably, the first stage start position of hood 12 corresponds to the pop-up position of hood 12, which, as previously noted, is selected to be about 25 mm raised relative to the fully-closed position in accordance with this non-limiting embodiment. The first stage end position for hood 12 can be selected as required for each vehicular application but, in this non-limiting example, is selected to be about 8 mm raised relative to the fully-closed position of hood 12. To provide the first cinching stage, power actuator 38 and drive cam 60 are configured to move lift lever 70 from its spring-released (i.e. deployed) position to its spring-loaded (i.e. non-deployed or home) position, in opposition to the biasing of lift lever spring 72, to permit hood 12 to move (under its own weight) from its first stage start/pop-up position into its first stage end position. Thus, the term “non-driven” is intended to define that ratchet 40 is not cinched via a power-operated arrangement, such as via latch cinch mechanism 36, during the first cinching stage so as to inhibit pinching of fingers, though it is contemplated herein that the cinching operation can be fully driven under the power of power actuator 38, if preferred.

FIGS. 9A and 9B, in comparison to FIGS. 8A and 8B, respectively, illustrate initiation of the first cinching stage by power actuator 38 being placed in a power-on state to cause driven rotation of drive cam 60 in the actuation direction from its safety pawl released position to a fourth or “first stage cinch start” position in response to hood 12 being manually moved from its fully-open position to its pop-up position. Such manual movement of hood 12 to its pop-up position also results in latch mechanism 30 shifting back into its secondary latched state with safety latch mechanism 130 shifted back into its safety latched state. As such, ratchet 40 is driven by striker 22 into its secondary striker capture position, whereat blocker lug 162 on safety pawl 142 engages secondary latch shoulder 49. In addition, FIGS. 9A and 9B also illustrate follower lug 120 on lift lever 70 now engaging a cinch edge surface 170 (See arrow “H”) formed on drive cam lift lever 62 and which is profiled to cause lift lever 70 to pivot about lift lever pivot post 78 in the downward direction opposing the normal biasing of lift lever spring 72. Such downward pivotal movement of lift lever 70 towards its non-deployed position causes striker 22 and hood 12 to move downward, due to the weight of hood 12, as striker 22 maintains engagement with striker lug 88 (See arrow “E”).

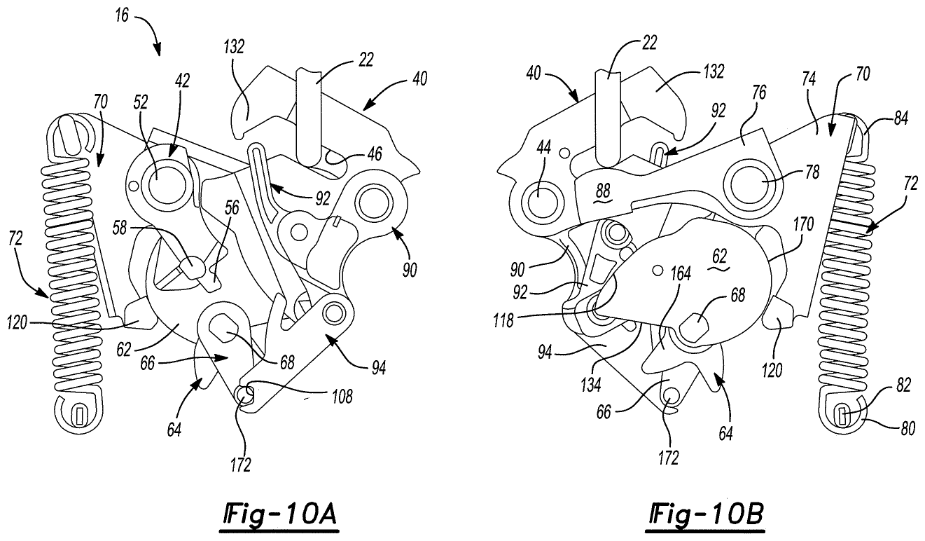

FIGS. 10A and 10B, in comparison to FIGS. 9A and 9B, respectively, illustrate continued driven rotation of drive cam 60 in the actuation direction from its first stage cinch start position toward a fifth or “first stage cinch end” position. Concurrently, the weight of hood 12 continues to cause striker 22 to act on ratchet 40 within guide channel 46 and forcibly rotate ratchet 40, in opposition to ratchet biasing member 50, from its secondary striker capture position toward its cinched striker capture position. As such, hood 12 moves downwardly from its pop-up position toward its cinched position. Note also that striker 22 continues to act on striker lug 88 for forcibly rotating lift lever 70, in opposition to lift lever spring 72, toward its non-deployed position. In addition, the profile of cinch edge surface 170 also assists in driving lift lever 70 toward its non-deployed position during such rotation of drive cam 60 toward its first stage cinch end position. Furthermore, drive cam 60 has rotated such that a cinch lever drive post 172 extending from drive cam cinch lever 66 is now shown positioned within drive slot 108 of transmission lever 94, thereby coupling latch cinch mechanism 36 to drive cam 60. As such, latch cinch mechanism 36 is shifted from its uncoupled state into a coupled state. At this point in the first cinching stage, cinch pawl 92 has not yet moved into engagement with ratchet 40.

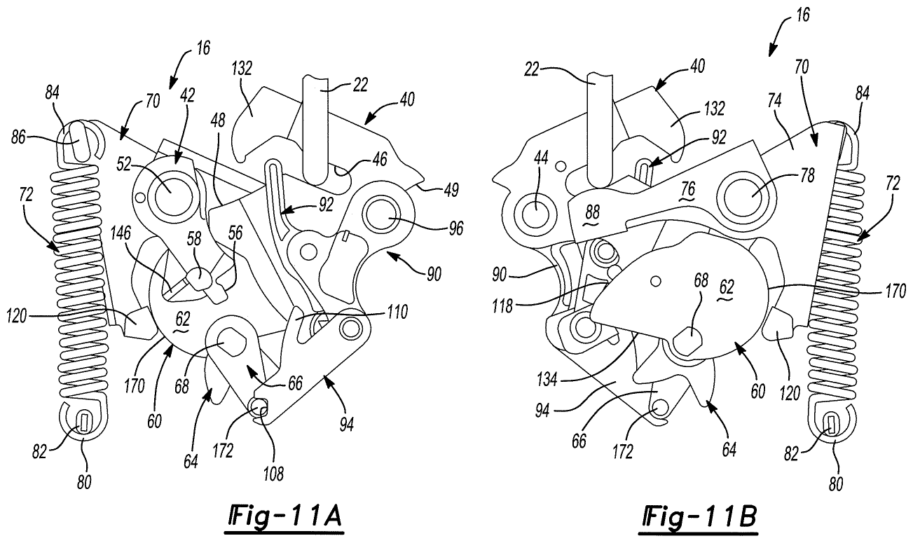

FIGS. 11A and 11B, in comparison to FIGS. 10A and 10B, respectively, illustrate the continued rotation of ratchet 40 toward its cinched striker capture position due to continued engagement with striker 22, and also illustrate the continued rotation of lift lever 70 toward its non-deployed position due to striker 22 acting on striker lug 88 and due to cinch edge surface 170 on drive cam lift lever 62 acting on follower lug 120. These drawings illustrate drive cam 60 rotated to its first stage cinch end position such that hood 12 is now located in its cinched position (between its pop-up and fully-closed position) raised about 8 mm relative to its fully-closed position. This cinched position of hood 12 defines the end point of the first cinching stage and the start point of the second cinching stage of the dual-stage cinch operation with ratchet 40 located in its cinched striker capture position. Note that engagement of cinch lever drive post 172 within drive slot 108 has caused drive cam cinch lever 66 to initiate movement of transmission lever 94 from its home position toward a second or “cinched” position. Such initial movement of transmission lever 94 also causes corresponding movement of both cinch pawl 92 and cinch lever 90 from their respective home positions toward their second or “cinched” positions. However, cinch pawl 92 is still not forcibly acting on ratchet 40 (See arrow “I”). Cinch edge surface 170 on drive cam lift lever 62 continues to drive follower lug 120 to rotate lift lever 70 in a downward direction toward its non-deployed position. However, striker 22 and hood 12 no longer follow along with continued rotation of lift lever 70 due to seal loading acting thereon.

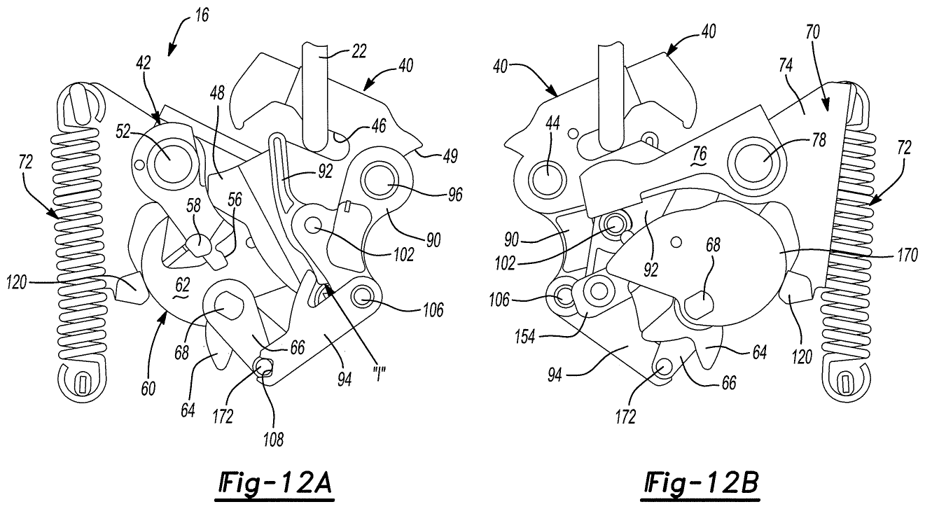

FIGS. 12A and 12B are generally similar to FIGS. 11A and 11B, respectively, but now illustrate drive cam 60 slightly further rotated by power actuator 38 in the actuation direction from its first stage cinch end position into a sixth or “second stage cinch start” position whereat cinch pawl 92 has moved into engagement with ratchet 40 (See arrow “I”) so as to initiate the second cinching stage of the dual-stage cinch operation. Note that transmission lever 94 continues to be driven by drive cam cinch lever 66 toward its cinched position (due to retention of cinch lever drive post 172 within drive slot 108) which likewise continues to drive cinch pawl 92 and cinch lever 90 toward their respective cinched positions.

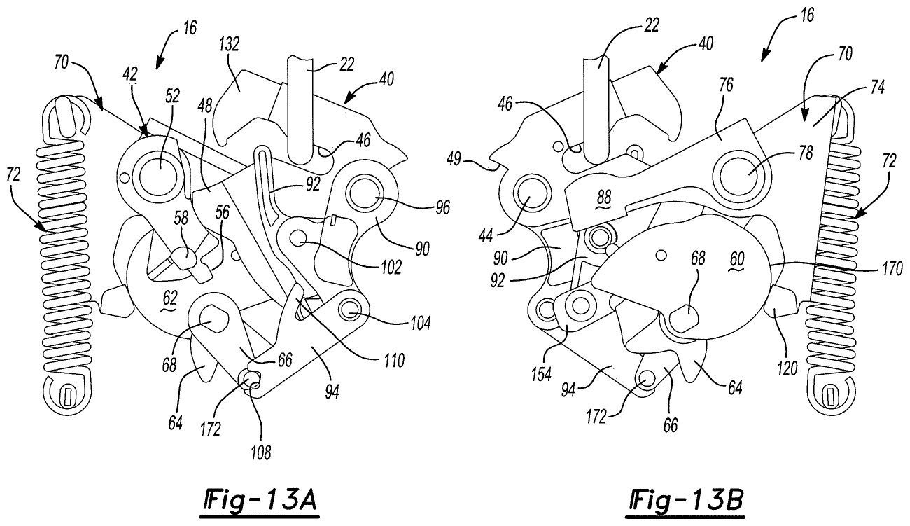

FIGS. 13A and 13B are generally similar to FIGS. 12A and 12B, respectively, and illustrate slightly further rotation of drive cam 60 in the actuation direction toward a seventh or “second stage cinch end” position. Such rotation of drive cam 60 causes drive cam cinch lever 66 to continue movement of the components of latch cinch mechanism 36 such that cinch pawl 92 continues to move toward its cinched position. Since cinch pawl 42 is now acting on ratchet 40, such movement of cinch pawl 42 towards its cinched position also acts to forcibly drive ratchet 40 from its cinched striker capture position toward its primary striker capture position. This driven cinching movement of ratchet 40 causes ratchet 40 to act on and move striker 22 which, in turn, causes hood 12 to move from its cinched position toward its fully-closed position.

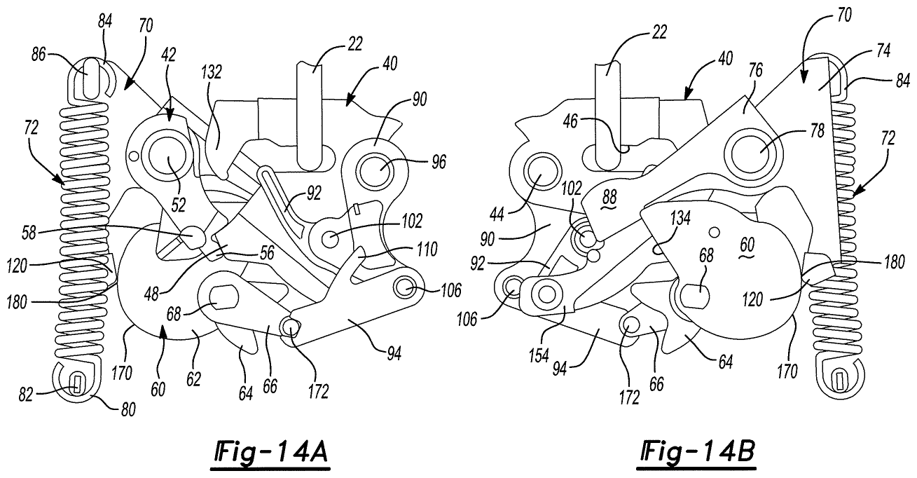

FIGS. 14A and 14B are generally similar to FIGS. 13A and 13B, respectively, and illustrate hood 12 now located in its fully-closed position with cinch pawl 92 located in its cinched position, with ratchet 40 located by cinch pawl 92 into its primary striker capture position, and with pawl 42 located in its ratchet holding position, all in response to driven rotation of drive cam 60 into its second stage cinch end position. Note that further rotation of drive cam 60 no longer causes downward movement of lift lever 70 which is now positioned in its non-deployed position due to follower lug 120 acting on a neutral surface segment 180 formed on cinch edge surface 170.

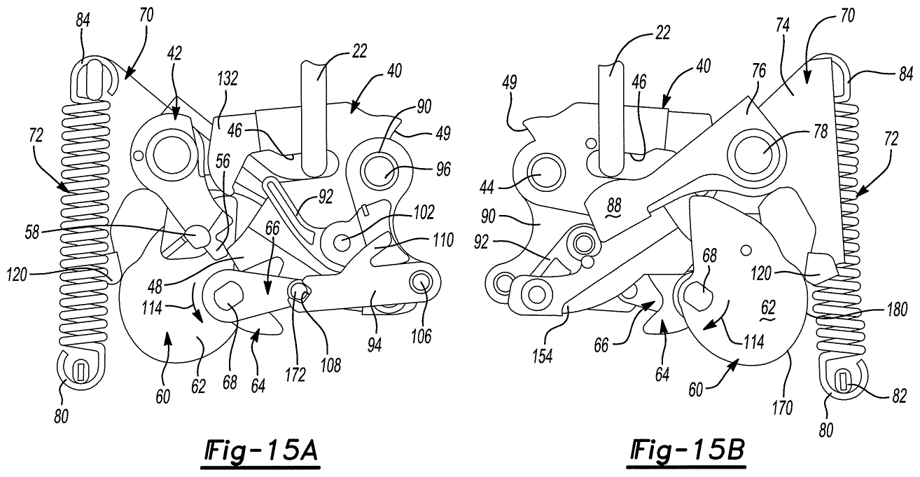

FIGS. 15A and 15B illustrate, in direct comparison to FIGS. 14A and 14B, respectively, continued driven rotation of drive cam 60 via power actuator 38 in the actuation direction into an eighth or “overtravel” position which, in turn, locates each of transmission lever 94, cinch pawl 92, and cinch lever 90 in their respective cinched position. As such, ratchet 40 (via its continued engagement with cinch pawl 92) is moved to its overtravel striker capture position which is, in this non-limiting embodiment, located about 2 mm past its primary striker capture position. The clearance between striker 22 and striker lug 88 on lift lever 70 results in all cinching of striker 22 being caused via engagement of striker 22 with ratchet 40. The generally “on-center” alignment between drive cam cinch lever 66 and transmission lever 94 generates the maximum force within the system.

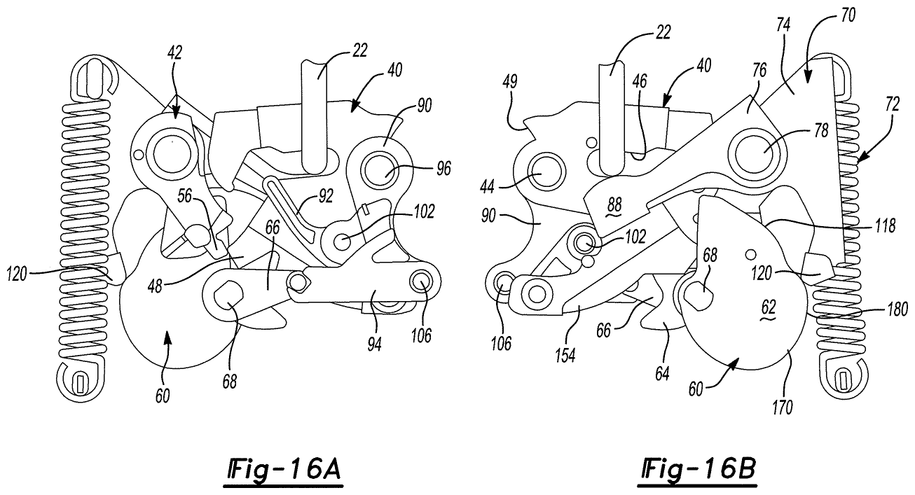

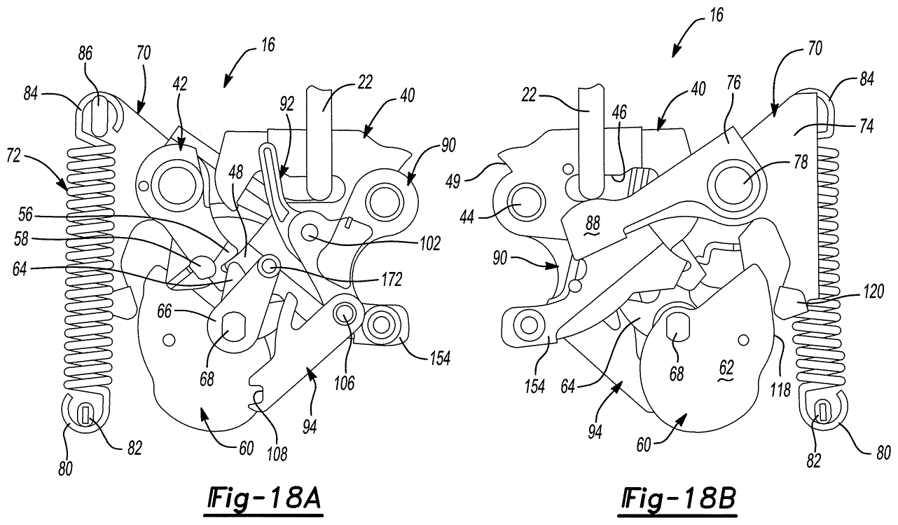

FIGS. 16A and 16B illustrate, in direct comparison to FIGS. 15A and 15B, respectively, that continued driven rotation of drive cam 60 in its actuation direction past its overtravel position causes ratchet 40 to move back toward its primary striker capture position and also acts to re-engage striker lug 88 on lift lever 70 with striker 22. FIGS. 17A and 17B illustrate the completion of the second cinching stage of the dual-stage cinch operation with hood 12 held by latch mechanism 30 in its fully-closed position. In particular, power actuator 38 has now driven drive cam 60 into a ninth or “cinch complete” position with latch mechanism 30 in its primary latched state, latch release mechanism 32 in its non-actuated state, and lift mechanism 34 in its spring-loaded state. Finally, FIGS. 18A and 18B illustrate continued driven rotation of drive cam 60 from the cinch complete position back into its home position such that latch cinch mechanism 36 is returned (i.e. “reset”) into its uncoupled state. Thus, a single rotation of drive cam 60 is used to provide the power release of latch mechanism 30, the power release of safety latch mechanism 130, the dual-stage cinching function including power cinching of latch cinch mechanism 36, and the resetting of closure latch assembly 16.

The present disclosure is directed to closure latch assembly 16 having latch mechanism 30 operable to releasably engage striker 22, latch release mechanism 32 operable to shift latch mechanism 30 from a latched state into an unlatched state, and power-operated actuator 38 operable for selectively actuating latch release mechanism 32 (both during normal, selective actuation via a user interface, and via automatic actuation via sensor 39′ detecting an imminent impact). Closure latch assembly 16 also includes spring-loaded lift mechanism 34 that is operable to move the closure panel, herein described as hood 12, from its fully-closed position to its partially-open position following actuation of latch release mechanism 32. Coordinated actuation of latch release mechanism 32 and safety latch mechanism 130 via power-operated actuator 38 provides the hood power release function.

The present disclosure is further directed to closure latch assembly 16 having latch cinch mechanism 36 that can be shifted from an uncoupled state into a coupled state via power-operated actuator 38 to provide the dual-stage hood cinching function. Latch cinch mechanism 36 is operable in its uncoupled state to permit hood 12 to move from its pop-up position to its cinched position, thereby establishing the first, non-driven cinching stage. Latch cinch mechanism 36 is operable in its coupled state to mechanically engage latch mechanism 30 and cause hood 12 to move from its cinched position into its fully-closed position, both via selective activation by an operator and via automated actuation, such as from a signal from sensor 39″, by way of example and without limitation, thereby establishing the second, driven cinching stage. Upon completion of the second cinching stage, power-operated actuator 38 is reset in anticipation of a request for a subsequent power release function. A single actuator arrangement is employed for power-operated actuator 38, which is configured to control the coordinated actuation of latch release mechanism 32 and safety latch mechanism 130, the resetting of spring-loaded lift mechanism 34, and the shifting of latch cinch mechanism 36 into its coupled state. To this end, a single cam arrangement, herein disclosed as drive cam 60, is driven in a single (i.e., “actuation”) direction from a home position through a series of distinct actuation positions to provide these coordinated power release, power cinch and resetting functions. While not shown, the actuation of power actuator 38 via latch controller 37 is controlled in response to a power-release signal from a remote keyless entry system (via actuation of a key fob or proximity) to provide these advanced convenience features.

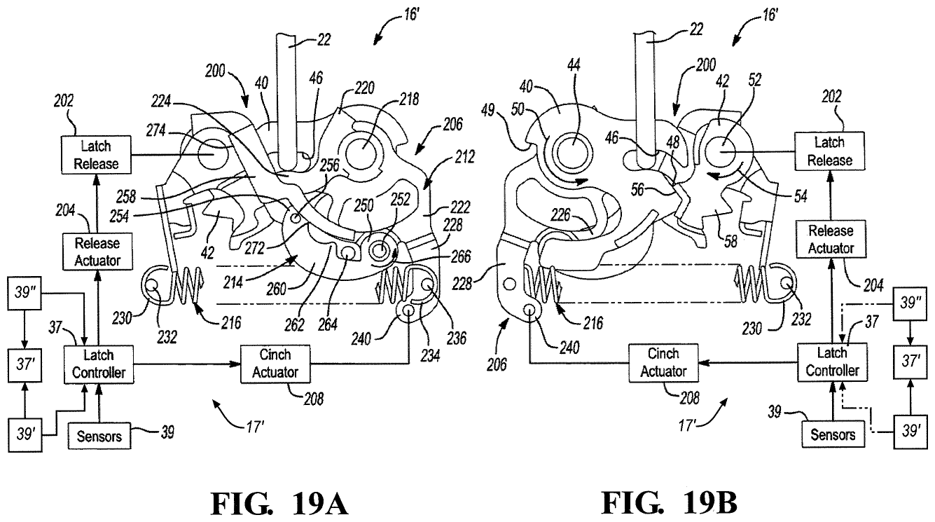

As noted, closure latch assembly 16 of FIGS. 2-18 is equipped with an “integrated” power actuator 38 configured to provide control over both the power release and the power cinch functions. However, some closure latch assemblies are configured to work in conjunction with an external cinch actuator that is separate and distinct from an internal power release actuator. To accommodate such arrangements, the present disclosure also contemplates an alternative version of closure latch assembly 16, identified as closure latch assembly 16′ in FIGS. 19 through 28, and to which the following detailed description is directed.

A detailed description of a non-limiting example embodiment of closure latch assembly 16′ of a closure latch system 17′, constructed in accordance with the teachings of the present disclosure, will now be provided. Referring initially to FIGS. 19A and 19B, closure latch assembly 16′ is generally shown to include a latch mechanism 200, a latch release mechanism 202, safety latch mechanism 130 (FIG. 8C), an electromechanical actuator, also referred to as power release actuator 204, and an “integrated” lift and cinch mechanism 206, all of which are supported within the latch housing. Lift and cinch mechanism 206 is considered to be “integrated” because it combines the functions of lift mechanism 34 and latch cinch mechanism 36 of closure latch assembly 16 into a common mechanism to provide reduced parts and simplify operation. Power release actuator 204 is operable for controlling actuation of latch release mechanism 202 which, in turn, controls coordinated actuation of latch mechanism 200 and safety latch mechanism 130. While only schematically shown, power release actuator 204 includes an electric motor and latch release mechanism 202 includes a revised version of drive cam 60 which is driven by the electric motor. In addition, a remotely-located electromechanical actuator, also referred to as power cinch actuator 208, is provided for controlling actuation of lift and cinch mechanism 206 to provide a dual-stage hood cinch operation. As before, the latch housing of closure latch assembly 16′ is fixedly secured to vehicle body 11 adjacent to the front compartment and defines an entry aperture through which striker 22 travels in response to movement of hood 12 relative to vehicle body 11.

Latch mechanism 200 is shown, in this non-limiting embodiment, to be generally similar to latch mechanism 30 and again includes a pawl and ratchet arrangement having ratchet 40 and pawl 42. Ratchet 40 is supported in the latch housing via ratchet pivot post 44 for rotational movement between several distinct positions including the striker release position, the secondary striker capture position, the cinched striker capture position, the primary striker capture position, and the overtravel striker capture position. Ratchet 40 includes primary latch shoulder 48 and secondary latch shoulder 49. Ratchet biasing member, schematically indicated by arrow 50, normally biases ratchet 40 toward its striker release position. Pawl 42 is supported in the latch housing via pawl pivot post 52 for movement between its ratchet holding position and its ratchet releasing position. Pawl biasing member, schematically indicated by arrow 54, normally biases pawl 42 toward its ratchet holding position. Pawl 42 includes pawl latch lug 56 and pawl release lug 58. FIGS. 19A and 19B illustrate ratchet 40 held in its primary striker capture position by pawl 42 located in its ratchet holding position due to pawl latch lug 56 engaging primary latch shoulder 48 on ratchet 40. Thus, closure latch assembly 16′ is operating in its primary latched mode.

Lift and cinch mechanism 206 is shown, in this non-limiting embodiment, to generally include a lift/cinch lever 212, a cinch pawl 214, and a lift lever spring 216. Lift/cinch lever 212 is pivotably mounted to the latch housing via a lift/cinch lever pivot post 218 which is shown to be commonly aligned with ratchet pivot post 44 to define a common pivot axis. Lift/cinch lever 212 is configured to include a lift lever segment 220 and a cinch lever segment 222. Lift lever segment 220 includes an elongated striker lug 224 adapted to selectively engage striker 22. Cinch lever segment 222 includes a body portion 226 and an elongated actuation portion 228 extending from body portion 226. Lift lever spring 216 has a first spring end 230 coupled to a stationary lug 232 extending from the latch housing and a second spring end 234 coupled to a retention lug 236 extending from actuation portion 228 of lift/cinch lever 212. Lift lever spring 216 is operable to normally bias lift/cinch lever 212 in a pop-up direction (i.e. clockwise in FIG. 19A and counterclockwise in FIG. 19B). Power cinch actuator 208 is schematically shown to act on an end segment 240 of actuation portion 228 of lift/cinch lever 212 and is operable for pivoting lift/cinch lever 212 about pivot post 218, in opposition to the biasing of lever spring 216. Cinch pawl 214 is shown to have a first end segment 250 pivotably coupled to body portion 226 of lift/cinch lever 212 via a cinch pawl pivot post 252, a second end segment 254 having a guide lug 256 configured to slide along a profiled cam surface formed on a guide rail portion 258 of the latch housing, and an intermediate segment 260 having a cinch pawl drive lug 262 configured to selectively engage a ratchet drive lug 264 extending from ratchet 40. A cinch pawl biasing member, schematically indicated by arrow 266, is operable to normally bias cinch pawl 214 in an engagement direction (i.e. clockwise in FIG. 19A and counterclockwise in FIG. 19B) to maintain sliding engagement of guide lug 256 with the cam surface on guide rail portion 258 of the latch housing.

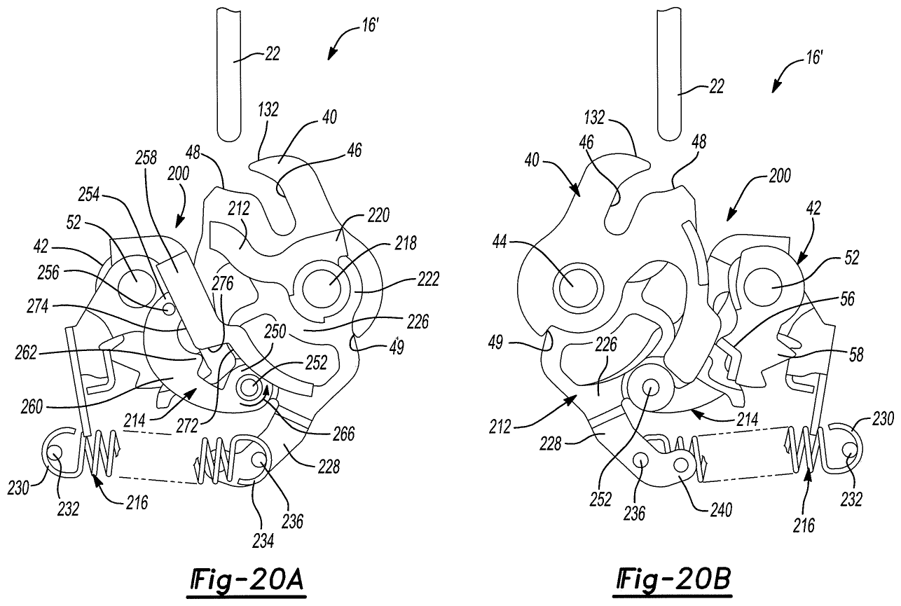

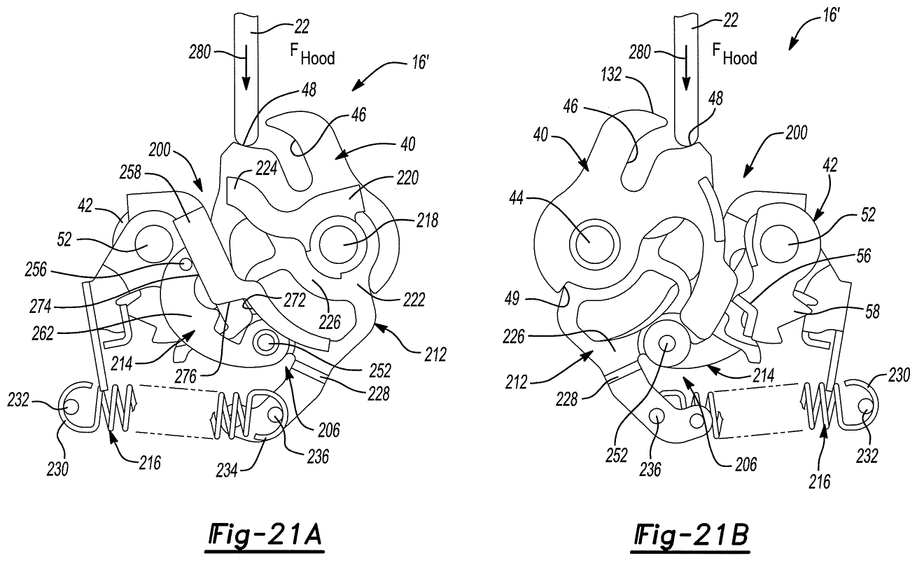

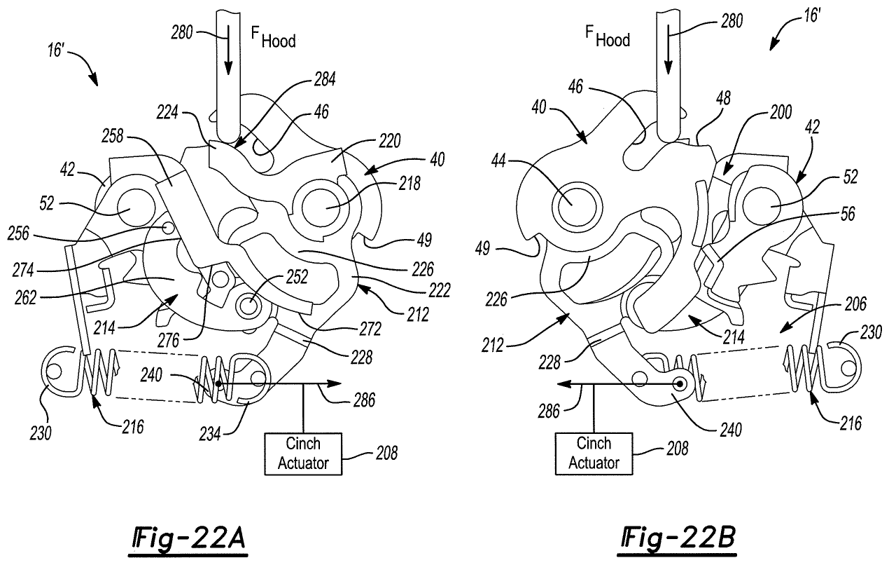

As will be hereinafter detailed, FIGS. 19 and 20 illustrate a power release operation provided in response to actuation of power release actuator 204, FIG. 21 illustrates a manual hood closing operation, and FIGS. 22-28 are a series of sequential views illustrating a dual-stage power cinch operation provided in response to actuation of power cinch actuator 208. Thus, FIGS. 19-28 are provided to illustrate movement of the various components of closure latch assembly 16′ required to provide these distinct operations.

FIGS. 19A and 19B illustrate closure latch assembly 16′ operating in its primary latched mode for holding hood 12 in its fully-closed position. With closure latch assembly 16′ in its primary latched mode, latch mechanism 200 is operating in its primary latched state with ratchet 40 held in its primary striker capture position by pawl 42 located in its ratchet holding position. In addition, latch release mechanism 202 is operating in its non-actuated state. Striker 22 is captured/retained within striker guide channel 46 of ratchet 40 such that striker 22 engages and acts on striker lug 224 on lift lever segment 220 of lift/cinch lever 212 so as to forcibly locate and hold lift/cinch lever 212 in a first or “non-deployed” position, in opposition to the normal biasing of lift lever spring 216, thereby placing lift/cinch lever 212 of lift and cinch mechanism 206 in its spring-loaded state. Cinch pawl 214 is shown biased into a first or “coupled” position via cinch pawl biasing member 266 such that its guide lug 256 engages a first or “inner” cam surface 272 formed on guide rail portion 258 of the latch housing, thereby placing cinch pawl 214 of lift and cinch mechanism 206 in its coupled state.

FIGS. 20A and 20B illustrate closure latch assembly 16′ operating in its released mode following completion of a power release operation, such as in response to a signal from one of sensor 39 and sensor 39′ via latch controller 37 and/or vehicle controller 37′, which causes hood 12 to initially move from its fully-closed position to its pop-up position (via power release of latch release mechanism 202) and which subsequently permits hood 12 to move from its pop-up position toward its fully-open position (via power release of safety latch mechanism 130). To provide this two-part power release operation, power release actuator 204 functions to shift latch release mechanism 202 from its non-actuated state into its actuated state for causing pawl 42 to be moved from its ratchet holding position into its ratchet releasing position, whereby ratchet biasing member 50 is permitted to move ratchet 40 from its primary striker capture position into its secondary striker capture position. Concurrently, lift lever spring 216 is permitted to move lift/cinch lever 212 from its non-deployed position toward a second or “deployed” position which assists in moving hood 12 to its pop-up position via engagement of striker lug 224 with striker 22, thereby placing lift/cinch lever 212 of lift and cinch mechanism 206 in its spring-released state. As before, safety latch mechanism 130 is operable in its safety latched state to hold ratchet 40 in its secondary striker capture position (via engagement of safety pawl lug 162 with ratchet secondary latch shoulder 49) to define the secondary latched state of latch mechanism 200. Continued actuation of power release actuator 204 functions to shift safety latch mechanism 130 into its safety unlatched state to disengage safety pawl 142 from ratchet 40, whereby ratchet biasing member 50 drives ratchet 40 to its ratchet released position (shown). Movement of lift/cinch lever 212 to its deployed position also results in concurrent movement of cinch pawl 214 from its coupled position to a second or “uncoupled” position, thereby placing cinch pawl 214 of lift and cinch mechanism 206 in its coupled state such that guide lug 256 engages a second or “outer” cam surface 274 formed on guide rail portion 258 of the latch housing. As seen, striker 22 is released from ratchet 40, thereby permitting opening movement of hood 12.

FIGS. 21A and 21B are generally similar to FIGS. 20A and 20B, respectively, but now illustrate a manual hood closing operation in which the weight of hood 12 (F_{HOOD}), schematically indicated by arrow 280, is shown acting on primary latch shoulder 48 of ratchet 40. This closing force 280 acts, in opposition to ratchet biasing member 50, to rotate ratchet 40 from its striker release position (shown) toward its secondary striker capture position whereat safety pawl 142 of safety latch mechanism 130 re-engages secondary latch shoulder 49 on ratchet 40 and establishes the secondary latched state of latch mechanism 200 such that hood 12 is held in its pop-up position.

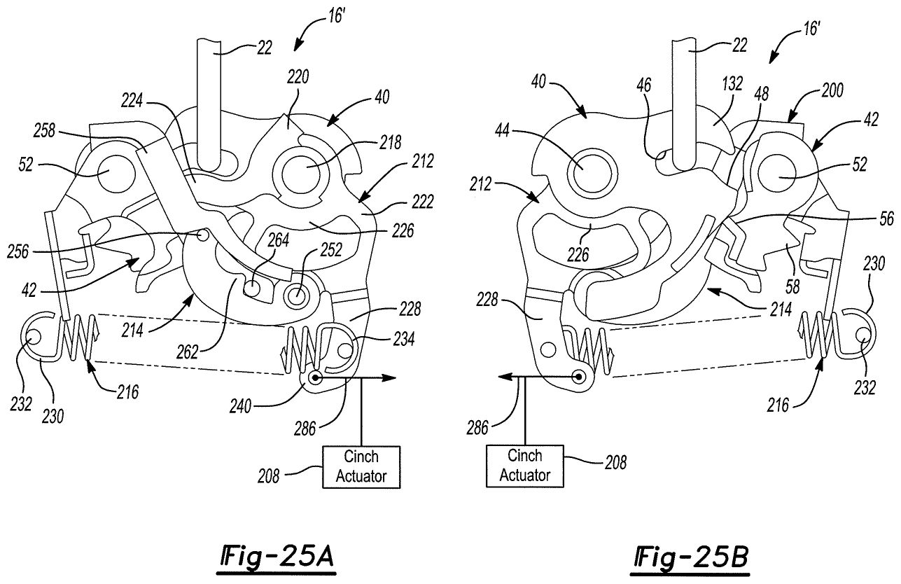

In accordance with the present disclosure, closure latch assembly 16′ is configured to provide a dual-stage hood cinch function via remotely-located power cinch actuator 208 controlling actuation of lift and cinch mechanism 206. As before, the first, non-driven cinching stage is operable to permit hood 12 to move under its own weight from its pop-up position to its cinched position while the second, driven cinching stage is operable to drive hood 12 from its cinched position to its fully-closed position. In this non-limiting embodiment, the pop-up position of hood 12 is selected to be about 25 mm raised relative to the fully-closed position while the cinched position of hood 12 is selected to be about 8 mm raised relative to the fully-closed position. In this regard, FIGS. 22-24 illustrate the first cinching stage while FIGS. 25-28 illustrate the second cinching stage.

Referring to FIGS. 22A and 22B, closure latch assembly 16′ is shown in its secondary latched mode with hood 12 held by latch mechanism 200 in its pop-up position. As such, latch mechanism 200 has been shifted back into its secondary latched state with safety latch mechanism 130 shifted into its safety latched state such that safety pawl 142 is located in its ratchet blocked position with its blocking lug 162 engaging secondary latch shoulder 49 on ratchet 40. As previously noted, the pop-up position of hood 12 preferably corresponds to the first stage start position for the first cinching stage. With hood 12 located in this position, striker 22 is engaging striker lug 224 on lift/cinch lever 212, as indicated by arrow 280, with lift/cinch lever 212 located in its deployed position. When sensors 39 detect an appropriate positioned signal, such as the location of ratchet 40 in its secondary striker capture position, power cinch actuator 208 is actuated to drive lift/cinch lever 212 from its deployed position toward its non-deployed position, in opposition to the biasing of lift lever spring 216. Otherwise, as discussed above, sensor 39″, upon not detecting an impact force against hood 12 during an initially detected imminent impact via sensor 39′, signals at least one of latch controller 37 and/or vehicle controller 37′ to actuate power cinch actuator 208. This actuation of power cinch actuator 208 is provided by an actuation force, indicated by force line 286, acting (i.e. pulling) on end portion 240 of actuation portion 228 of lift/cinch lever 212. This actuation force 286 may be generated by a cable pulling on lift/cinch lever 212 via a motor-driven cable/driven type cinch actuator. As an alternative, a linear-type cinch actuator can be used to generate and exert the actuation force 286. Thus, FIGS. 22A and 22B illustrate initiation of the first cinching stage. During the first cinching stage, cinch pawl drive lug 262 on cinch pawl 214 remains disengaged from ratchet drive lug 264 on ratchet 40. In particular, FIG. 22A shows cinch pawl 214 located in its uncoupled position with its guide lug 256 in engagement with second cam surface 274. As such, power cinch actuator 208 functions to move lift/cinch lever 212 downwardly towards its non-deployed position such that the weight (F_{HOOD}) 280 is solely responsible for movement of hood 12 from its pop-up position to its cinched position.

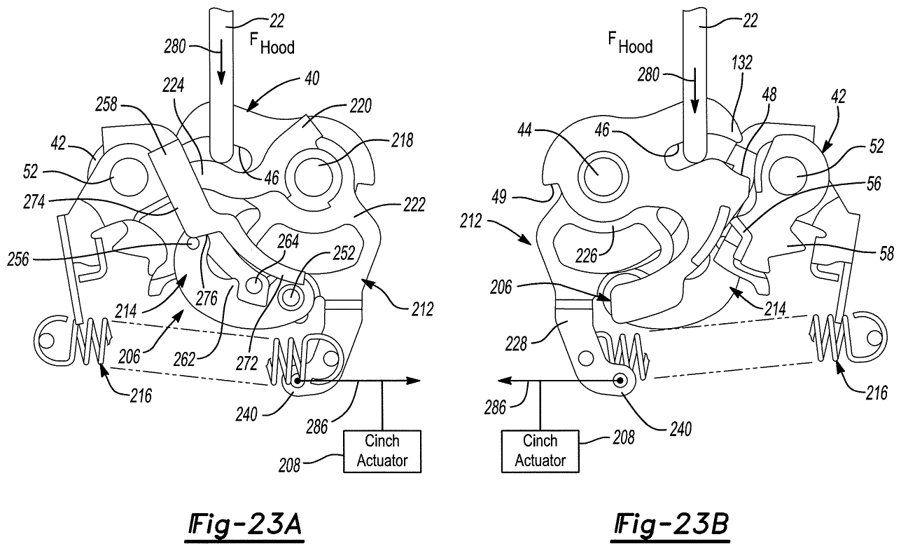

FIGS. 23A and 23B illustrate continuation of the first cinching stage with striker 22 continuing to drive ratchet 40 toward its cinched striker capture position. Concurrently, power cinch actuator 208 continues to drive lift/cinch lever 212 towards its non-deployed position. FIG. 23A shows guide lug 256 on cinch pawl 214 exiting engagement with second cam surface 274 along a transition surface 276 as cinch pawl 214 moves from its uncoupled position toward its coupled position. However, cinch pawl drive lug 262 is still displaced from engagement with ratchet drive lug 264. Thus, the weight (F_{HOOD}) of hood 12 continues to provide the first cinching stage.

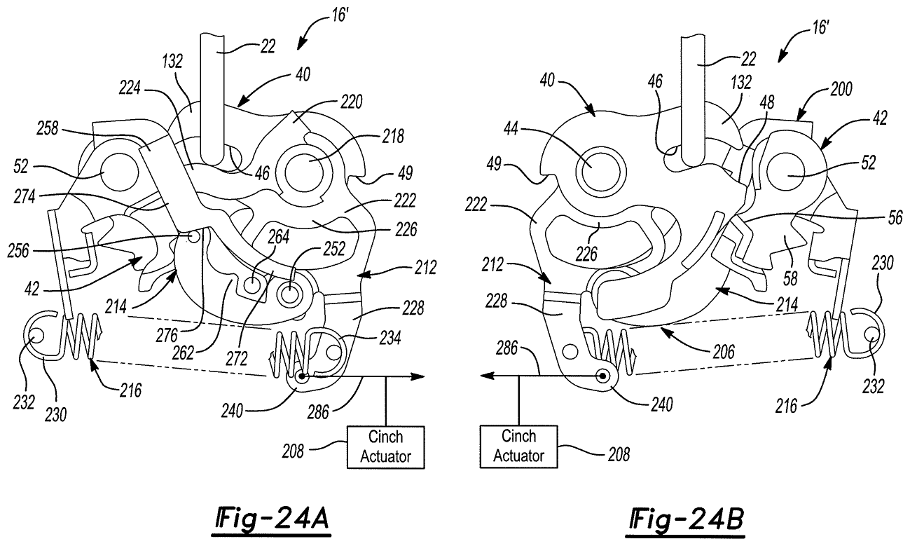

FIGS. 24A and 24B illustrate completion of the first cinching stage upon continued actuation of power cinch actuator 208 moving lift/cinch lever 212 toward its non-deployed position with hood 12 located in its cinched position and held there by ratchet 40 being located in its cinched striker capture position. However, striker 22 disengages striker lug 224 upon continued pivotal movement of lift/cinch lever 212 due to seal load influences. Note that continued movement of lift/cinch lever 212 towards its non-deployed position causes continued movement of cinch pawl towards its coupled position. As shown in FIG. 24A, cinch pawl drive lug 262 is still disengaged from ratchet drive lug 264 at the end of the first cinching stage.

FIGS. 25A and 25B are generally similar to FIGS. 24A and 24B, respectively, but illustrate initiation of the second cinching stage resulting from continued actuation of power cinch actuator 208. Specifically, cinch pawl 214 is now shown located in its coupled position with its guide lug 256 in sliding engagement with first cam surface 272 and cinch pawl drive lug 262 in engagement with ratchet drive lug 264. Thus, cinch pawl 214 of lift and cinch mechanism 206 has been shifted into its coupled state. Continued movement of lift/cinch lever 212 towards its non-deployed position causes cinch pawl 214 to forcibly move ratchet 40 from its cinched striker capture position toward its primary striker capture position. As such, ratchet 40 acts on striker 22 to drive hood 12 from its cinched position toward its fully-closed position.

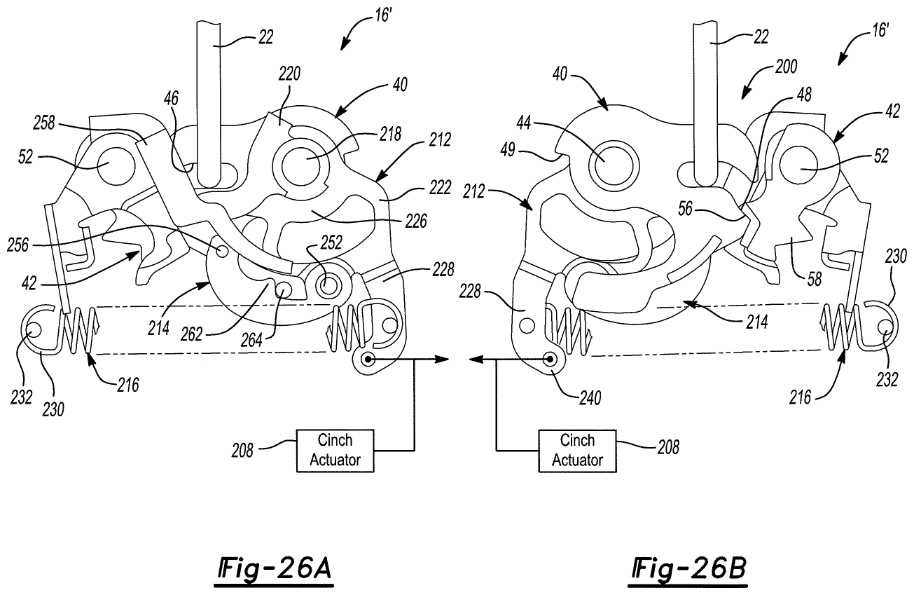

FIGS. 26A and 26B are generally similar to FIGS. 25A and 25B, respectively, but illustrate that movement of lift/cinch lever 212 into its non-deployed position results in cinch pawl 214 driving ratchet 40 into its primary striker capture position (shown). As such, pawl biasing member 54 forces pawl 42 to move into its ratchet holding position relative to ratchet 40 such that pawl latch lug 56 is aligned with primary latch shoulder 48 on ratchet 40. Note also that striker lug 224 on lift/cinch lever 212 is no longer engaged with striker 22 such that all cinching of hood 12 into its fully-closed position is provided via cinch pawl 214.

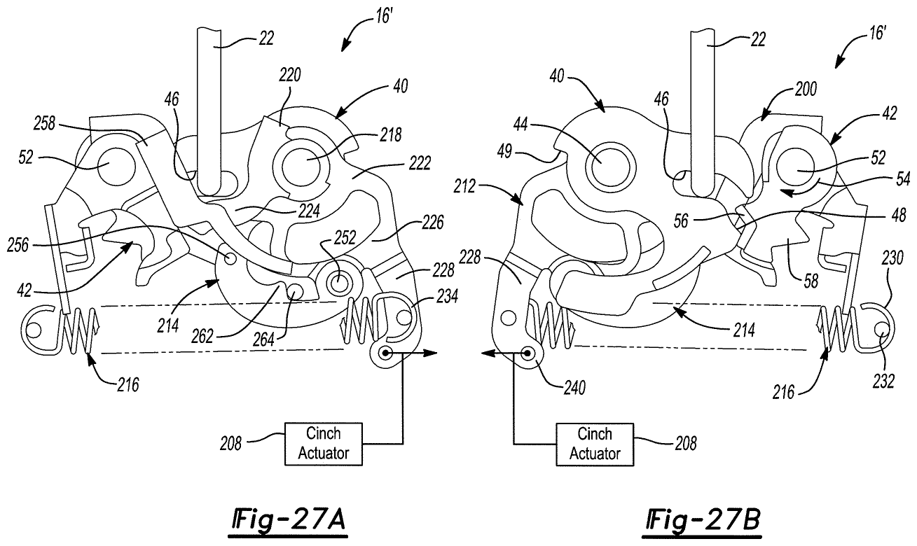

FIGS. 27A and 27B are generally similar to FIGS. 26A and 26B, respectively, but illustrate that continued movement of lift/cinch lever 212 slightly past its non-deployed position via continued actuation of power cinch actuator 208 has resulted in cinch pawl 214 driving ratchet 40 (via engagement of cinch pawl drive lug 262 with ratchet drive lug 264) into its overtravel striker capture position which, in this non-limiting embodiment, is about 2 mm past the hood fully-closed position.

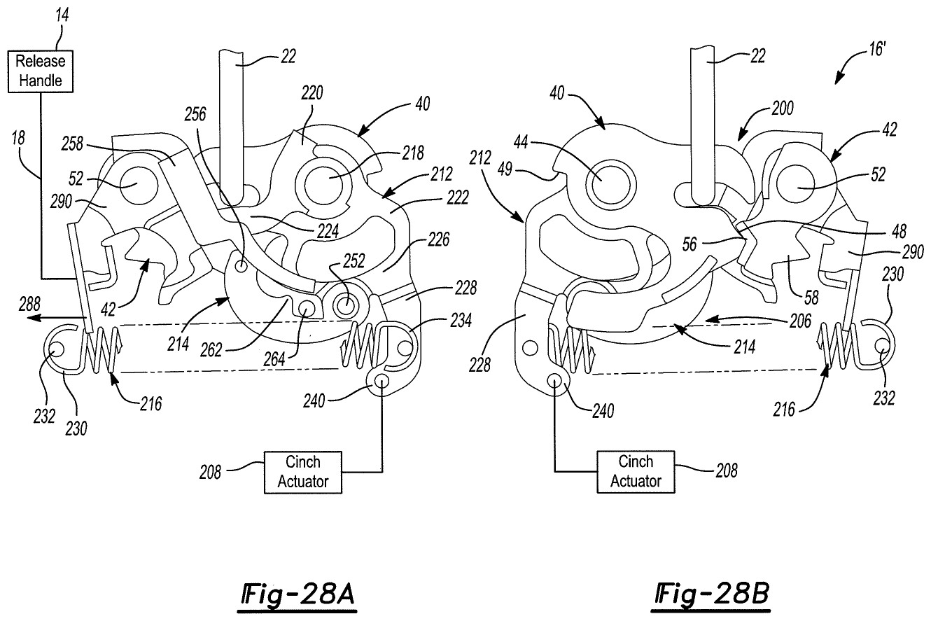

Finally, FIGS. 28A and 28B illustrate the end of the second cinching stage with power cinch actuator 208 shifted into a power-off condition. With no actuation force applied by power cinch actuator 208, lift/cinch lever 212 returns to its non-deployed position and cinch pawl 214 moves slightly to disengage cinch pawl drive lug 262 from ratchet drive lug 264. Thus, closure latch assembly 16′ is now operating in its primary latched mode with latch mechanism 200 in its primary latched state holding hood 12 in its fully-closed position. An emergency release lever 300 may be pivotally coupled about pawl pivot 52 and connected with release cable 18 to allow for a manual release of the latch mechanism 200 by activation of handle 14 (e.g. illustratively by a clockwise rotation of emergency release lever 300 of FIG. 28A imparted by the activation of cable 18 represented by arrow A18). Rotation of emergency release lever 300 imparts a rotation of pawl 42 towards the ratchet releasing direction. Through FIGS. 19A to 28B, stationary lug 232 may be illustratively coupled to emergency release lever 300 to increase the spring tension in lift lever spring 216 during a manual release to assist driving the lift/cinch lever 212 in the pop-up direction.

In each embodiment of closure latch assembly 16, 16′, the power cinch operation is divided into two stages. As detailed, the first cinching stage is intended to lower hood 12 via lowering of the lift lever 70, 212 from its pop-up height (i.e. 25 mm) to its cinched height (i.e. 8 mm). Due to the weight of hood 12 acting on lift lever 70, 212, hood 12 follows along from its partially-open position to its cinched position. This first (i.e. non-driven) stage prevents pinching of fingers. The second cinching stage is intended to cause latch cinch mechanism 36 and lift and cinch mechanism 206 to engage and drive ratchet 40 from its cinched striker capture position into its primary striker capture position, thereby mechanically pulling striker 22 for moving hood 12 from its cinched position into its fully-closed position.

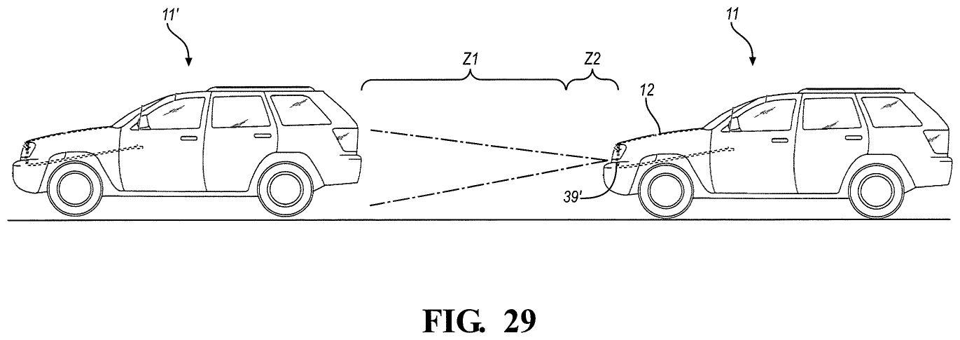

Now turning to FIGS. 29 through 33, a sequence events is illustrated showing detection of a pedestrian in a pedestrian protection zone and actuation of the power actuator 38 in an active pedestrian protection mode in response to the detection of pedestrian P in the pedestrian protection zone to lessen the impact force experienced by the pedestrian P upon impacting the hood 12 of the motor vehicle 11.

In FIG. 29, the motor vehicle 11 is illustrated be a predetermined distance behind another motor vehicle 11′, with the total predetermined distance being a combination of a predetermined forward collision/sensing zone, referred to hereafter as zone 1 (Z1), and the predetermined pedestrian protection zone, referred to hereafter as zone 2 (Z2). The distances of zones 1 and 2 can be selected as desired, wherein zone 1 can be provided to be between 0.1 to 10 meters, while zone 2 can be provided to be between 0.1 to 2 meters, by way of example and without limitation. It is to be recognized that some overlap of zones 1 and 2 can exist. When vehicle 11′ enters zone 1 (Z1), an advanced driver assistance system (ADAS) can be activated to automatically steer and/or brake vehicle 11 as needed to avoid impact with vehicle 11′, as well as avoid impact with other surrounding vehicles and objects (not shown). The ADAS system can be in operable communication with sensor 39′, if desired, and/or other sensors, as well as with vehicle controller 37′.

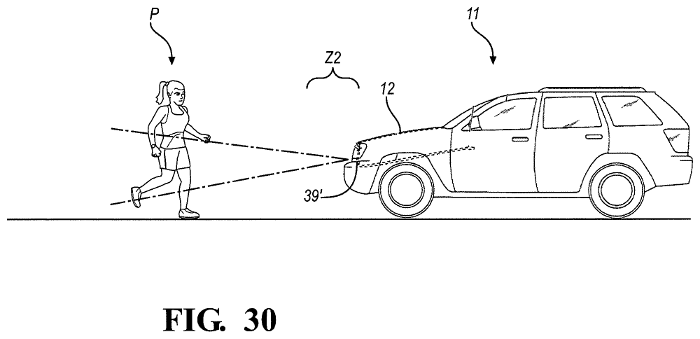

In FIG. 30, pedestrian P is shown within zone 1 (Z1), but outside of zone 2 (Z2), and thus, the ADAS system is activated to automatically steer and/or brake vehicle 11 in an effort to avoid hitting pedestrian P; however, sensor 39′ does not signal vehicle controller 37′ or latch controller 37 to actuate power actuator 38. Accordingly, closure latch assembly 16, 16′ and latch mechanism thereof remain in the fully latched state, thereby keeping hood 12 in its fully closed position.

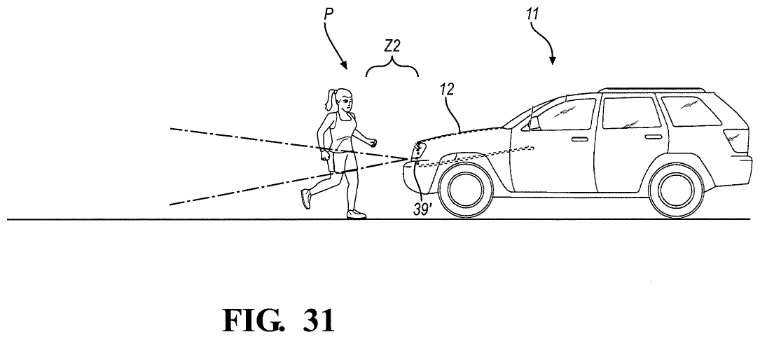

In FIG. 31, pedestrian P is shown having entered zone 1 (Z1), and as such, sensor 39′ detects an imminent side or frontal crash/impact with pedestrian P, thus, sensor 39′ communicates with vehicle controller 37′ and/or directly with controller 37 to actuate power actuator 38, 204 of closure latch assembly 16, 16′ to automatically move latch assembly 16, 16′ from its fully latched state to a partially unlatched state, such as shown in FIGS. 7A, 7B.

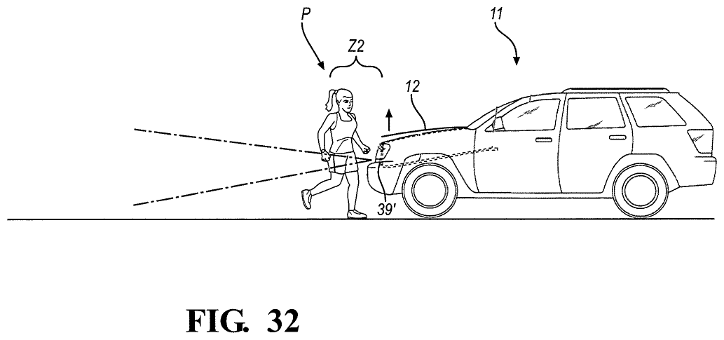

In FIG. 32, continued actuation of latch assembly 16, 16′ has occurred in response to pedestrian P being detected as being within zone 1 (Z1), with hood 12 shown being moved to its partially opened position (pop-up position). Pedestrian P still has not impacted motor vehicle 11.

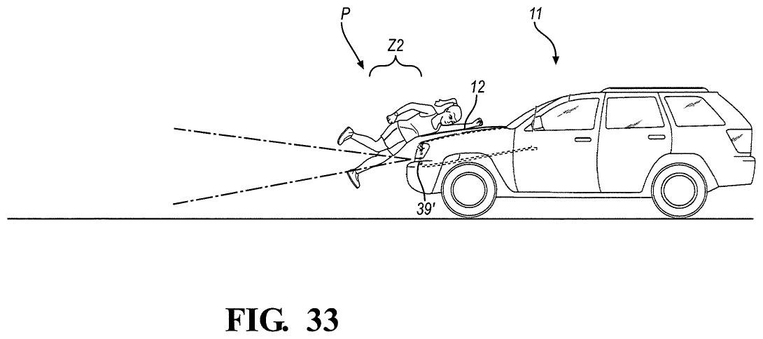

In FIG. 33, pedestrian P has impacted hood 12 of motor vehicle 11, with hood 12 being in its pop-up position. As such, with hood 12 raised away from the underlying motor in its pop-up position, an increased cushion of space between hood 12 and motor is provided, thereby reducing the potential of pedestrian P coming into abrupt impact with the engine.

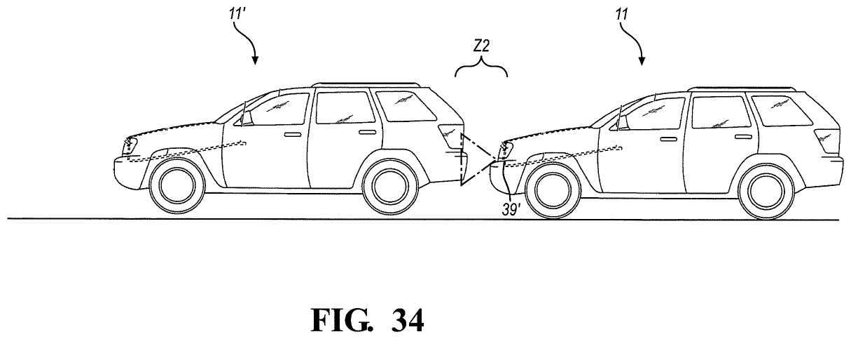

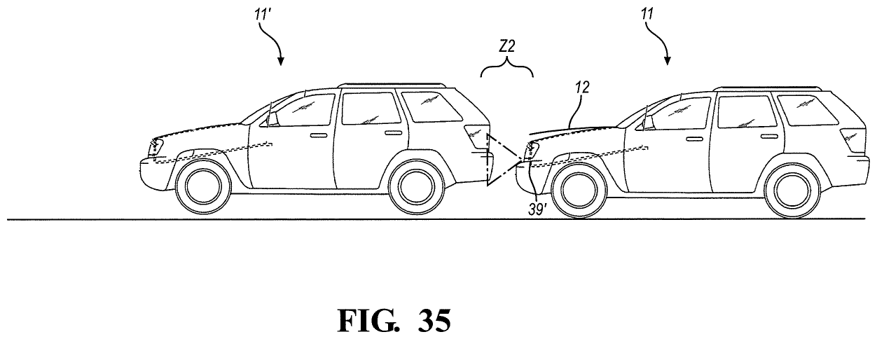

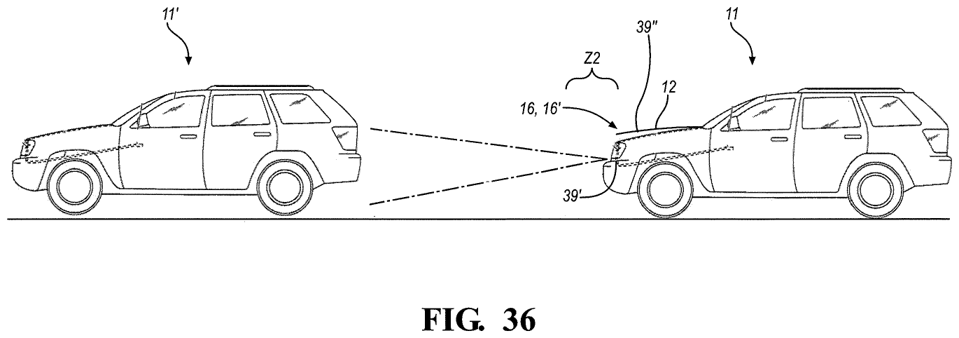

In FIGS. 34 and 35, a false detection of imminent impact is detected by sensor 39′, with motor vehicle 11′ having entered zone 2, thereby being detected by sensor 39′. As such sensor 39′, as shown in FIG. 35, triggers latch assembly 16, 16′ via vehicle controller 37′ and/or latch controller 37 to automatically move latch assembly 16, 16′ from its fully latched state to the partially unlatched state, whereat hood 12 is moved to the pop-up position. However, as shown in FIG. 36, nothing has impacted motor vehicle 11, as detected by sensor 39″, and sensor 39′ no longer detects an object in the second zone (Z2), as vehicle 11′ has moved outside of second zone (Z2), and thus, sensor 39″ signals latch assembly 16, 16′ via vehicle controller 37′ and/or latch controller 37 to automatically move latch assembly 16, 16′ from its fully partially unlatched state to its latched state, whereat hood 12 is returned from the pop-up position to the fully closed position. It is to be recognized that latch assembly 16, 16′ can also be returned to from the pop-up position to the fully closed position via manual actuation, as discussed above. Regardless, motor vehicle 11 can remain in operation during the false detection event without stopping, all while hood 12 is caused to move to the pop-up position and back to the fully closed position. The use of a resettable mechanism, such as a cinching latch for reloading a spring to be reset for a subsequent active pedestrian event, provides for multiple active pedestrian protection events, in other words the hood 12 can be moved to active pedestrian protection height or position, without the need for a replacement of any components, such as a pyrotechnic device, or destructive element, which would require for example the user to return to a service station to have the device replaced with another single use mechanism for moving the hood 12 to an active pedestrian protection position. The system and latches describe herein may be provided with a multi-use, resettable, energy storage device, such as a spring, and may not be provided with a single-use, non-resettable, energy storage device, such as a chemical based pyrotechnic device as an example.

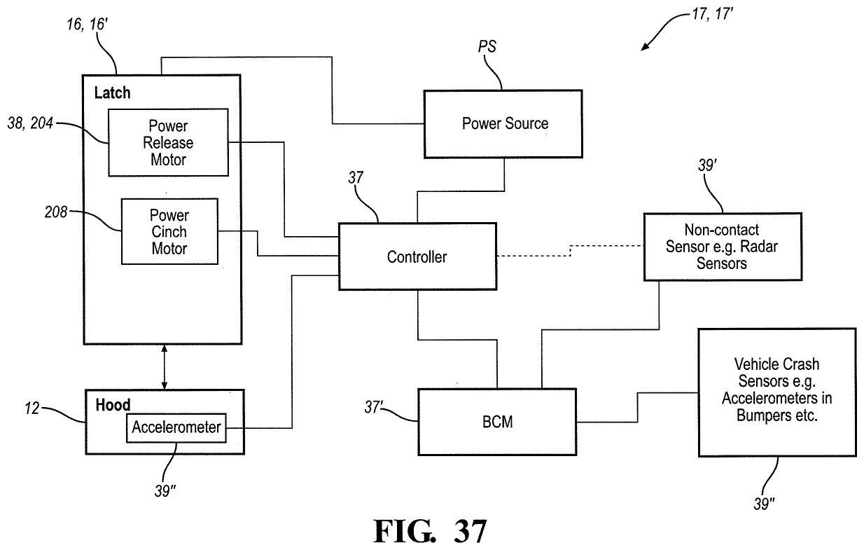

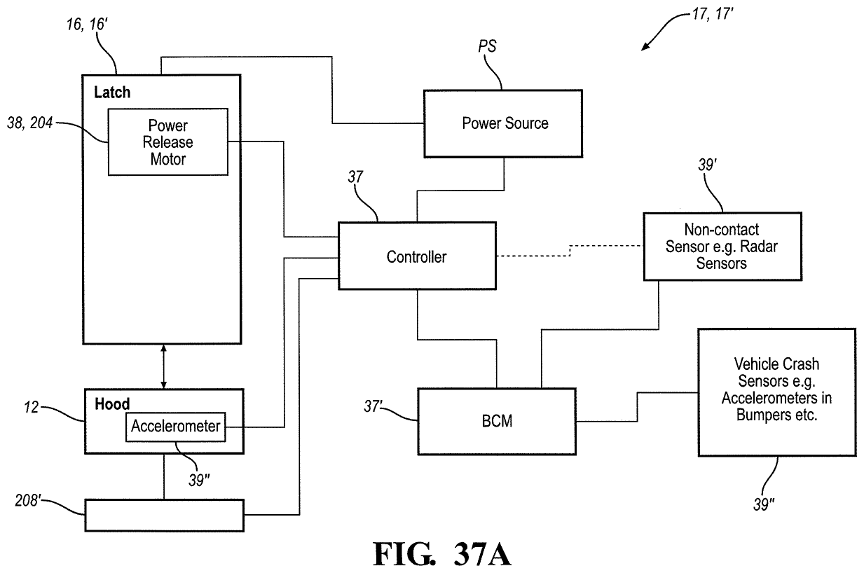

In FIG. 37, a flow diagram illustrates the communication between the various latch system components as discussed above, with a power source PS of the motor vehicle 11 shown in electrical communication with latch controller 37 and latch assembly 16, 16′.

In FIG. 37A, a block diagram illustrates the connections between the various latch system components as discussed above in accordance with another alternate configuration whereby a cinching system 208′ is not part of latch assembly 16, 16′ but rather a standalone unit having a power actuator for operating a cinch mechanism to move the closure panel from the deployed position to the closed position. The illustrative cinching mechanisms are illustrative of a resetting device for moving the closure panel from the deployed position in a resetting mode to a closed position after a false detection of a pedestrian. Optionally the resetting device may be operable in the resetting mode to return the closure panel from the deployed position to the closed position after a pedestrian impact.

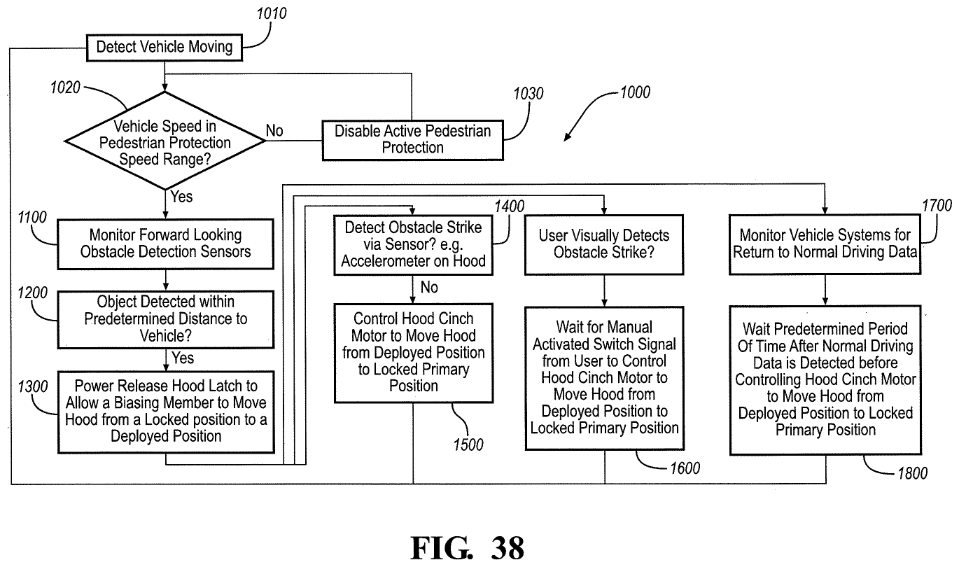

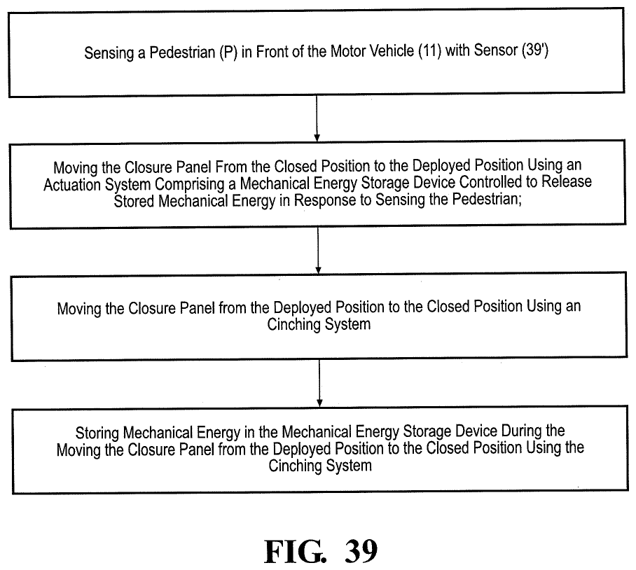

In accordance with another aspect of the disclosure, FIG. 38 illustrates a method 1000 of automatically moving a hood 12 of a motor vehicle 11 from a closed state to a partially open state in advance of impacting a pedestrian P to minimize the potential for injury to the pedestrian P upon the pedestrian impacting the hood 12, and returning the hood 12 from the partially open state to the closed state is provided. The method 1000 includes a step 1010 of detecting the vehicle moving, for example receiving a speed signal of the vehicle from the BCM. The method 1000 includes a step 1020 of determining if the detected vehicle speed is within a pedestrian protection speed range. For example the pedestrian protection speed range is not a speed of 0 kph when the vehicle is stationary nor is it a high speed for example above 40 kph. If at step 1020 a determination is made that the speed of the vehicle is not within the pedestrian protection speed range the active pedestrian system is disabled at step 1030. For example the pedestrian protection speed range may be within a speed of 30 to 40 kph. The method 1000 further includes a step 1100 of monitoring the forward looking sensors 39′ for detection of an object, including a pedestrian P, which may include receiving data from the forward looking sensors 39′ already controlled by another system such as an ADAS system; The method 1000 further includes a step 1100 of monitoring the forward looking sensors 39′ is not already controlled by another system; Next, a step 1200 of sensing a pedestrian P in front of the motor vehicle 11 with a sensor 39′; a step 1300 of sending a signal from the sensor 39′ to a controller 37, 37′ and sending a signal from the controller 37, 37′ to at least one electromechanical actuator 38, 204 of a latch assembly 16, 16′ in response to the signal sent from the sensor 39′ to the controller 37, 37′, whereupon the at least one electromechanical actuator 38, 204 moves at least one pawl 42 from a primary lock position, whereat the at least one pawl 42 holds a ratchet 40 in the striker capture position to maintain the hood 12 in the closed state, to a ratchet releasing position, whereat the at least one pawl 42 temporarily releases the ratchet 40 and allows a biasing member, such as lift lever 70, to pivot from a home position to a deployed position in forcible engagement with the striker 22 to move the hood 12 to the partially open state, whereat the ratchet 40 is maintained in a secondary striker capture position to maintain the hood 12 in the partially open state. The method 1000 further includes a step 1400 of determining whether or not an object impacted the motor vehicle 11, and if no impact is detected, a step 1500 of sending a signal from the controller 37, 37′ to the at least one electromechanical actuator 38, 208 to return the ratchet 40 from the striker partial release position to the striker capture position, whereat the ratchet 40 retains the striker 22 in a fully closed position and the hood 12 in the fully closed position. The method 1000 further includes a step 1700 of monitoring other vehicle systems for return of normal driving data, such as receiving speed data from the BCM indicating the vehicle is moving, and next a step 1800 of waiting for a predetermined period of time, such as 10 seconds after the detected normal driving data is detected before controlling sending a signal from the controller 37, 37′ to the at least one electromechanical actuator 38, 208 to return the ratchet 40 from the striker partial release position to the striker capture position, whereat the ratchet 40 retains the striker 22 in a fully closed position and the hood 12 in the fully closed position. Steps 1500, 160, 1700 may return to step 1010 thereafter.

In accordance with another aspect of the disclosure, the method 1000 can further include automatically sending the signal from the controller 37, 37′ to the at least one electromechanical actuator 38, 208 to return the ratchet 40 from the striker partial release position to the striker capture position whereat the ratchet 40 retains the striker 22 in a fully closed position and the hood 12 in the closed position in response to an impact detection sensor 39″, configured in electrical communication with the controller 37, 37′, not detecting an impact against the motor vehicle 11.

In accordance with another aspect of the disclosure, the method 1000 can further include configuring the sensor 39′ to detect an object in a first zone Z1 associated with an advanced driver assistance system, whereat the at least one electromechanical actuator 38, 204 is not actuated, and to detect a pedestrian P in a second zone Z2, whereat the at least one electromechanical actuator 38, 204 is actuated, the second zone Z2 extending from a front end of the motor vehicle 11 to the first zone Z1 such that the second zone Z2 is between the first zone Z1 and the motor vehicle 11.

In accordance with another aspect of the disclosure, the method 1000 can further include a step 1600 of sending the signal from the controller 37, 37′ to the at least one electromechanical actuator 38, 208 to return the ratchet 40 from the striker partial release position to the striker capture position, whereat the ratchet 40 retains the striker 22 in a fully closed position and the hood 12 in the closed position, in response to an operator actuating a cinch mechanism, configured in electrical communication with the controller 37, 37′.

In accordance with another aspect of the disclosure, the method 1000 can further include providing the at least one electromechanical actuator including a power release motor 204 and a separate power cinch motor 208 and configuring the power release motor 204 to pivot the at least one pawl 42 out of locked engagement with the ratchet 40 and configuring the power cinch motor 208 to return the ratchet 40 from the striker partial release position to the striker capture position whereat the ratchet 40 retains the striker 22 in a fully closed position and the hood 12 in the fully closed position.

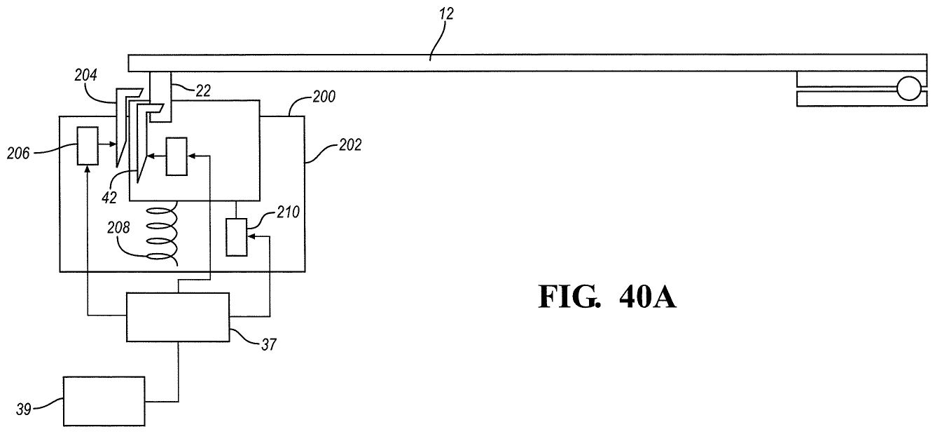

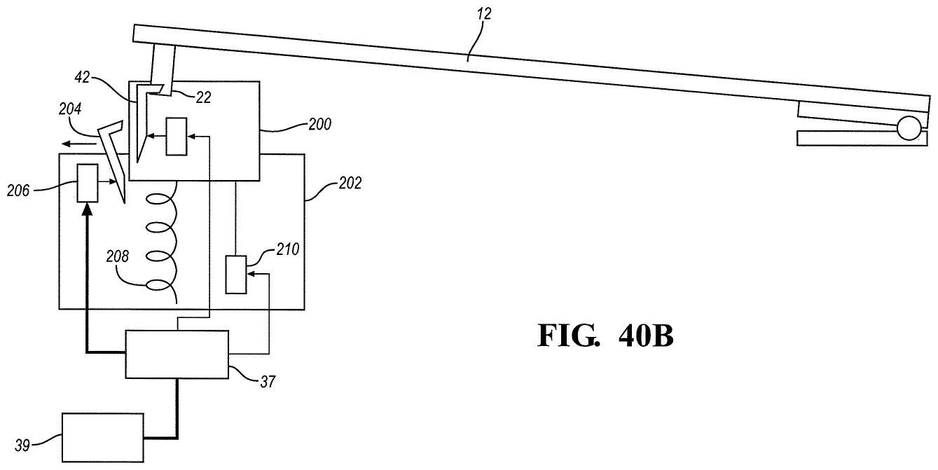

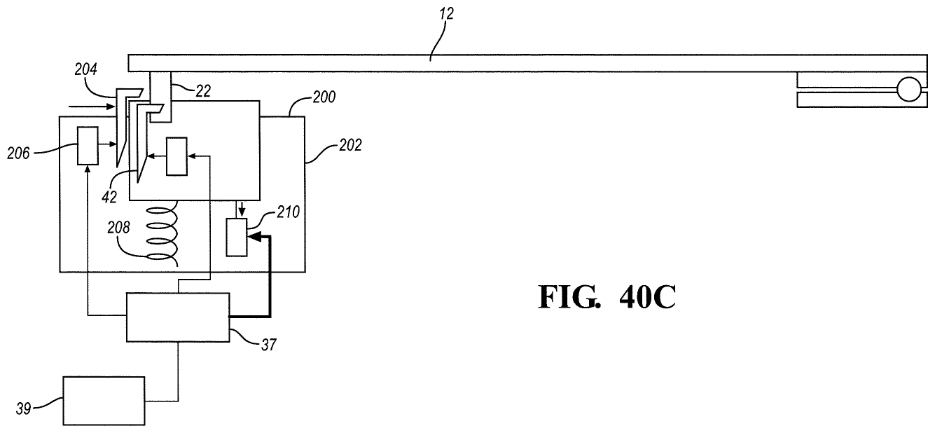

FIGS. 40A to 40C show a sequence of an active pedestrian protection system deployment in response to a sensor 39′ detecting a pedestrian in the impact zone with a latch assembly 16″ configured to allow the hood 12 to reach a deployed position without the latch assembly 16′″ releasing the striker 22 e.g. power actuator 38, 204 operable coupled to pawl 42 is not activated during an active pedestrian protection condition. Latch assembly 16′″ is configured therefore to have two moveable plates 200, 202 relative to each other retained by a releasable and resettable catch mechanism 204 moveable by a power actuator 206 in communication with controller 37. When controller 37 determines an active pedestrian protection condition, controller 37 controls power actuator 206 to decouple plates 200, 202 by moving catch mechanism 204 allowing a mechanical actuation system shows as spring 208 to move the plates relative to each other thereby urging the striker 22 and the 12 to the active pedestrian deployed position (FIG. 40B). When controller 37 determines an active pedestrian protection condition has been a false activation, in manners as described herein above, the controller 37 commands a cinch system 210 to act between plates 200, 202 to return the plates in latch position with one another such that the hood 12 returns to a fully closed position whereat catch mechanism 204 is engages to retain the plates 200, 204 in locked engagement with one another (FIG. 40C). Cinch system 210 may also be part of a powered actuator for moving the hood 12 to the fully opened position, but also be used for returning the hood to a fully closed position as an example. During the cinched return of the hood from the deployed position to the fully closed position, the moving the closure panel from the deployed position to the closed position using the cinching system 210 the mechanical actuation system is recharged for storing mechanical energy for readiness for a next active pedestrian protection condition, and without the need for requirement replacement of parts or return to a servicing station of the active pedestrian protection system for resetting.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An active pedestrian protection system for moving a closure panel of a motor vehicle between a fully closed position and a partially open position, comprising:
a latch mechanism configured for retaining a striker coupled to the closure panel in a fully captured position, whereat the closure panel is in the fully closed position, a striker partial release position, whereat the closure panel is in the partially open position, and a striker release position, whereat the closure panel is permitted to move to a fully open position;
an actuation system comprising an actuation device having a first state and a second state wherein transition of the actuation device from the first state to the second state causes movement of the closure panel from the fully closed position to the partially open position, and at least one power actuator operable to promote a transition of the actuation device from the first state to the second state;
at least one sensor configured for sensing an object within a predetermined distance from the motor vehicle; and
at least one controller in communication with the at least one power actuator and with the at least one sensor, the at least one controller being configured to control the at least one power actuator in response to receiving a signal from the at least one sensor to cause the actuation device to transition from the first state to the second state, whereat the striker moves from the fully captured position to the striker partial release position and the closure panel moves from the fully closed position to the partially open position.

2. The active pedestrian protection system of claim 1, wherein the at least one sensor includes an impact detection sensor configured in communication with the at least one controller, the impact detection sensor being configured to detect an object impacting the motor vehicle, wherein the at least one controller is configured to signal the at least one power actuator, wherein absent receipt of a signal by the impact detection sensor indicating an object impacting the hood, the impact detection sensor signals the at least one controller to actuate the at least one power actuator to return the hood to the fully closed position.

3. The active pedestrian protection system of claim 2, wherein the impact detection sensor automatically signals the at least one controller to actuate the at least one power actuator to return the hood to the fully closed state within a preset timeframe without input from a user.

4. The active pedestrian protection system of claim 1, wherein the actuation device is a spring, wherein the first state corresponds to a loaded state of the spring and the second state corresponds to a released state of the spring.

5. The active pedestrian protection system of claim 1, wherein the actuation device is not a pyrotechnic device.

6. The active pedestrian protection system of claim 1, wherein the latch mechanism includes a ratchet and at least one pawl, the ratchet being moveable between a primary striker capture position whereat the ratchet retains the striker in the fully captured position and whereat the hood is in the fully closed position, a striker partial release position whereat the ratchet retains the striker in the partially released position and whereat the hood is in the partially open position, and a striker release position whereat the ratchet releases the striker and whereat the hood can be moved to a fully open position, the at least one pawl being moveable between a lock position whereat the at least one pawl holds the ratchet in one of the primary striker capture position or the striker partial release position, and a ratchet releasing position whereat the at least one pawl releases the ratchet for movement from one of the primary striker capture position or the striker partial release position.

7. The active pedestrian protection system of claim 6, further including a lift lever configured to move from a home position to a deployed position, wherein the at least one power actuator is configured for communication with the at least one sensor, the at least one power actuator being in operable communication with the lift lever and the at least one pawl, the at least one power actuator being actuatable in response to a signal from the at least one sensor to move the at least one pawl from the lock position to the ratchet releasing position and to move the lift lever from the home position to the deployed position to move the striker from the fully captured position to the partially released position and the hood from the fully closed position to the partially open position, and the at least one power actuator being actuatable to return the striker from the partially released position to the fully captured position and the hood from the partially open position to the fully closed position.

8. The active pedestrian protection system of claim 6, wherein the at least one power actuator includes a power release motor and a power cinch motor, the power release motor being configured to move the at least one pawl from the lock position to the ratchet releasing position and the power cinch motor being configured to return the striker from the partially released position to the fully captured position and the hood from the partially open position to the fully closed position.

9. The active pedestrian protection system of claim 1, wherein the at least one sensor includes a non-contact sensor configured to detect an object in a first zone, whereat the at least one power actuator is not actuated, and to detect a pedestrian in a second zone, whereat the at least one power actuator is actuated, the second zone extending from a front end of the motor vehicle to the first zone.

10. The active pedestrian protection system of claim 9, wherein the at least one sensor is part of an advanced driver assistance system, wherein the advanced driver assistance system is configured to automatically steer and/or brake the motor vehicle upon detection of an object in the first zone.

11. A closure latch system for capturing, partially releasing and recapturing a striker of a hood of a motor vehicle, comprising:
a ratchet and at least one pawl, the ratchet being moveable between a striker capture position whereat the ratchet retains the striker in a fully captured position and whereat the hood is in a fully closed position, a striker partial release position whereat the ratchet retains the striker in a partially released position and whereat the hood is in a partially open position, and a striker release position whereat the ratchet releases the striker and whereat the hood can be moved to a fully open position, the at least one pawl being moveable between a primary lock position whereat the at least one pawl holds the ratchet in the striker capture position and a ratchet releasing position whereat the at least one pawl releases the ratchet to the striker partial release position;
a lift lever configured to pivot from a home position to a deployed position in forcible engagement with the striker; and
at least one power actuator configured for communication with at least one sensor, the at least one power actuator being in operable communication with the lift lever and the at least one pawl, the at least one power actuator being actuatable in response to a signal from the at least one sensor to pivot the at least one pawl out of locked engagement with the ratchet and to pivot the lift lever from its home position to its deployed position into forcible engagement with the striker to move striker to the partially released position and the hood to the partially open position, and the at least one power actuator being actuatable after receiving the signal from the at least one sensor to return the striker to the fully captured position and the hood to the fully closed position.

12. The closure latch system of claim 11, further including at least one controller configured in communication with the at least one sensor, wherein the at least one controller is configured to signal the at least one power actuator, upon receipt of a signal from the at least one sensor, to pivot the at least one pawl out of locked engagement with the ratchet and to pivot the lift lever from its home position to its deployed position into forcible engagement with the striker to move and support the hood in the partially open position, and thereafter to signal the at least one power actuator to pivot the lift lever from its deployed position to its home position out of forcible engagement with the striker and to cause the ratchet to return to the striker capture position and return the hood to the fully closed state.

13. The closure latch system of claim 12, wherein the at least one sensor includes an impact detection sensor configured in communication with the at least one controller, the impact detection sensor being configured to detect an object impacting the motor vehicle, wherein upon lack of receipt of a signal from the impact detection sensor indicating an object impact, the at least one controller is signaled to actuate the at least one power actuator to return the hood to the fully closed state.

14. The closure latch system of claim 11, wherein the at least one power actuator includes a power release motor and a power cinch motor, the power release motor being configured to pivot the at least one pawl out of locked engagement with the ratchet and the power cinch motor being configured to return the striker from the partially released position to the fully captured position and the hood from the partially open position to the fully closed position.

15. The closure latch system of claim 11, wherein the at least one sensor is configured to detect an object in a first zone associated with an advanced driver assistance system, whereat the at least one power actuator is not actuated, and to detect a pedestrian in a second zone, whereat the at least one power actuator is actuated, the second zone extending from a front end of the motor vehicle to the first zone such that the second zone is between the first zone and the motor vehicle.

16. The closure latch system of claim 15, wherein the at least one sensor is part of an advanced driver assistance system, wherein the advanced driver assistance system is configured to automatically steer and/or brake the motor vehicle upon detection of an object in the first zone.

17. The closure latch system of claim 11, wherein the closure latch system is not equipped with a pyro actuator for assisting with the movement of the striker to the partially released position and the hood to the partially open position.

18. An active pedestrian protection system for moving a closure panel of a motor vehicle between a fully closed position and a partially open position, comprising:
a latch mechanism configured for retaining a striker coupled to the closure panel in a fully captured position, whereat the closure panel is in the fully closed position, a striker partial release position, whereat the closure panel is in the partially open position, and a striker release position, whereat the closure panel is permitted to move to a fully open position; and
an actuation system comprising an actuation device having a first state and a second state wherein transition of the actuation device from the first state to the second state causes movement of the closure panel from the fully closed position to the partially open position in an active pedestrian protection mode, and at least one power actuator operable to promote a transition of the actuation device from the first state to the second state in a resetting mode.

19. The active pedestrian protection system of claim 18, wherein the actuation system is in communication with a sensor system for detecting a pedestrian at a distance from the vehicle, the actuation system configured to transition from the first state to the second state in response to receiving a signal from the sensor system.

20. The active pedestrian protection system of claim 18, wherein the actuation system is configured to control the latch mechanism to release the striker from the fully captured position to the striker partial release position in the active pedestrian protection mode and is further configured to control the latch mechanism to move the striker from the striker partial release position to the fully captured position in the resetting mode.
